(19) United States
(12) Patent Application Publication
(10) Pub. No.: US 2026/0156683 A1
(43) Pub. Date: Jun. 4, 2026

(54) SMALL DATA TRANSMISSION USING MSG1 PRACH

(71) Applicant: QUALCOMM Incorporated, San Diego, CA (US)

(72) Inventors: Raviteja PATCHAVA, San Diego, CA (US); Jing SUN, San Diego, CA (US); Linhai HE, San Diego, CA (US); Jing JIANG, San Diego, CA (US)

(21) Appl. No.: 18/968,648

(22) Filed: Dec. 4, 2024

(51) Int. Cl. H04W 74/0833; H04L 27/26

(52) U.S. Cl. CPC H04W 74/0833; H04L 27/2678

(57) ABSTRACT

The apparatus may be a UE configured to transmit, via a first set of resources associated with a first RO, a first random access message (Msg 1) using a first preamble sequence, transmit, via a second set of resources associated with a second RO, an additional first random access message (additional Msg 1) using a second preamble sequence associated with a first cyclic shift value that indicates support for a capability of the UE, wherein the additional Msg 1 is based on the Msg 1, and receive a second random access message (Msg 2) based on the Msg 1 and the additional Msg 1.

### TECHNICAL FIELD

The present disclosure relates generally to communication systems, and more particularly, to a random access process for initial access.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device such as a user equipment (UE) configured to transmit, via a first set of resources associated with a first random access channel (RACH) occasion (RO), a first random access message (Msg 1) using a first preamble sequence, transmit, via a second set of resources associated with a second RO, an additional first random access message (additional Msg 1) using a second preamble sequence associated with a first cyclic shift value that indicates support for a capability of the UE, where the additional Msg 1 is based on the Msg 1, and receive a second random access message (Msg 2) based on the Msg 1 and the additional Msg 1.

In an aspect of the disclosure, a method, a computer-readable medium, and an apparatus are provided. The apparatus may be a network node such as a base station configured to receive, from a UE via a first set of resources associated with a first RO, a first random access message (Msg 1) using a first preamble sequence, receive, from the UE via a second set of resources associated with a second RO, an additional first random access message (additional Msg 1) using a second preamble sequence associated with a first cyclic shift value that indicates support for a capability of the UE, where the additional Msg 1 is based on the Msg 1, and transmit, to the UE, a second random access message (Msg 2) based on the Msg 1 and the additional Msg 1.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates example aspects of a random access procedure between a UE and a base station.

FIG. 5A is a diagram illustrating a mapping between a set of ROs associated with first random access messages of a random access procedure and a set of additional ROs associated with additional first random access messages of the random access procedure indicating additional information relating to the transmitting device in accordance with some aspects of the disclosure.

FIG. 5B is a diagram illustrating a mapping between a set of ROs associated with first random access messages of a random access procedure and an additional RO associated with additional first random access messages of the random access procedure indicating additional information relating to the transmitting device in accordance with some aspects of the disclosure.

FIG. 6 is a diagram illustrating the use of the additional first random access message to transmit additional information in accordance with some aspects of the disclosure.

FIG. 7 is a diagram illustrating a first technique for collision handling in accordance with some aspects of the disclosure.

FIG. 8 is a diagram illustrating a first technique for collision avoidance in accordance with some aspects of the disclosure.

FIG. 9 is a call flow diagram illustrating a method of wireless communication in accordance with some aspects of the disclosure.

FIG. 10 is a flowchart of a method of wireless communication.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

FIG. 14 is a diagram illustrating an example of a hardware implementation for an example network entity.

### DETAILED DESCRIPTION

In some aspects of wireless communication, a random access, or initial access, procedure may be performed between a user equipment (UE) and a base station. The may receive information from a base station indicating a set of ROs (e.g., sets of time-and-frequency resources available for transmitting messages associated with the RACH procedure) and associated preambles for the RACH procedure. To initiate the RACH procedure, the UE may select a preamble from a plurality of preambles associated with an RO and transmit a first message of the RACH procedure (which may be referred to as a msg1, msg 1, Msg1, or Msg 1) using the selected preamble in the resources of the RO. The selected preamble, in some aspects, may be selected from the set of preambles indicated by the base station and may be based on a root of the sequence and cyclic shift (CS) value that can be used to differentiate between different first messages sent by different users (e.g., devices or UEs) via, in, or associated with, a same RO.

The base station may detect the first message and transmit a second message of the RACH procedure (which may be referred to as a msg2, msg 2, Msg2, or Msg 2) based on the detected preamble. The second message of the RACH procedure, in some aspects, may include an allocation of resources for a third message (which may be referred to as a msg3, msg 3, Msg3, or Msg 3) of the RACH procedure from the UE. In some aspects, there may be restrictions for allocating resources for the third message for certain users (e.g., based on a capability of a UE or wireless device performing the RACH procedure). For example, one or more bandwidth (BW) or other restrictions may be applied for one or more classes of reduced capability (eRedCap) devices (e.g., eRedCap users). Knowledge of the features and/or capabilities of the UE or wireless device performing the RACH procedure may be used to allocate resources that are supported or compatible with a particular device. However, before an initial attachment or access, there are challenges associated with indicating the capabilities of the wireless device and/or UE performing the RACH procedure. In some aspects, a few bits of information may be carried in the preamble selection associated with the first msg (e.g., PRACH msg1) based on sequence splitting, where the PRACH sequences (sometimes referred to as preamble sequences) are split (or partitioned) into multiple groups, with each group representing or being associated with a certain PRACH configuration (e.g., a configuration for the RACH procedure associated with a UE and/or device capability or class). In some aspects, a partitioning of PRACH, or preamble, sequences may increase collisions within each group. The likelihood of a collision, in some aspects, may increase as the number of partitions increases, e.g., as the number of PRACH configurations that may be indicated by the selection of a preamble sequence from a particular preamble sequence partition increases.

Various aspects relate generally to a technique for transmitting a small number of bits of information over a first message (e.g., msg1) for a UE having particular capabilities, such as reduced capabilities. In some aspects, the UE may be an eRedCap UE. Some aspects more specifically relate to a technique to transmit a small amount of information (e.g., one or more bits of information) using a an additional msg1 (e.g., a special msg1) transmission utilizing CS dithering (e.g., a CS adjustment or shift). In some aspects, the amount of CS dithering, or adjustment may be detected by a receiving base station and be mapped to, or used to identify, a class of UE or a UE capability. In some examples, a wireless device may be configured to transmit, via a first set of resources associated with a first RO, a first random access message (Msg 1) using a first preamble sequence, transmit, via a second set of resources associated with a second RO, an additional first random access message (additional Msg 1) using a second preamble sequence associated with a first cyclic shift value that indicates support for a capability of the UE, where the additional Msg 1 is based on the Msg 1, and receive a second random access message (Msg 2) based on the Msg 1 and the additional Msg 1. In certain aspects, a network node (e.g., a base station) may be configured to receive, from a UE via a first set of resources associated with a first RO, a first random access message (Msg 1) using a first preamble sequence, receive, from the UE via a second set of resources associated with a second RO, an additional first random access message (additional Msg 1) using a second preamble sequence associated with a first cyclic shift value that indicates support for a capability of the UE, where the additional Msg 1 is based on the Msg 1, and transmit, to the UE, a second random access message (Msg 2) based on the Msg 1 and the additional Msg 1.

Particular aspects of the subject matter described in this disclosure can be implemented to realize one or more of the following potential advantages. In some examples, by utilizing CS dithering (e.g., a CS shift or CS adjustment), the described techniques can be used to indicate, in a first message of a RACH procedure, information used to allocate resources for a third message of the RACH procedure, e.g., to allocate resources that are compatible with the capability of a device and/or UE associated with the RACH procedure, while reducing the likelihood of collisions associated with the use of preamble partitioning to indicate the information.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

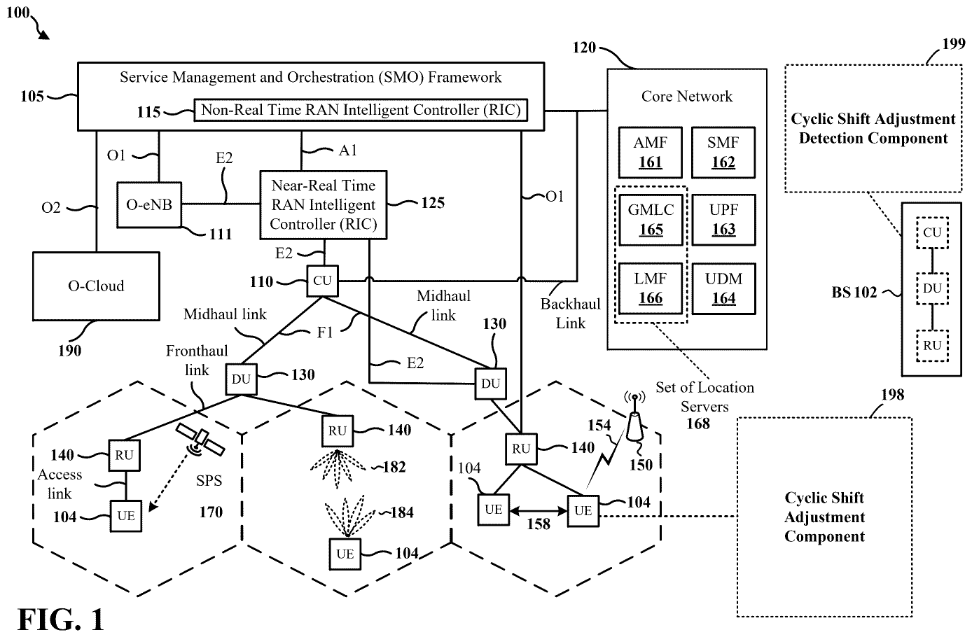

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a CS adjustment component 198 that may be configured to transmit, via a first set of resources associated with a first RO, a first random access message (Msg 1) using a first preamble sequence, transmit, via a second set of resources associated with a second RO, an additional first random access message (additional Msg 1) using a second preamble sequence associated with a first cyclic shift value that indicates support for a capability of the UE, where the additional Msg 1 is based on the Msg 1, and receive a second random access message (Msg 2) based on the Msg 1 and the additional Msg 1. In certain aspects, the base station 102 may have a CS adjustment detection component 199 that may be configured to receive, from a UE via a first set of resources associated with a first RO, a first random access message (Msg 1) using a first preamble sequence, receive, from the UE via a second set of resources associated with a second RO, an additional first random access message (additional Msg 1) using a second preamble sequence associated with a first cyclic shift value that indicates support for a capability of the UE, where the additional Msg 1 is based on the Msg 1, and transmit, to the UE, a second random access message (Msg 2) based on the Msg 1 and the additional Msg 1. Although the following description may be focused on 5G NR, the concepts described herein may be applicable to other similar areas, such as LTE, LTE-A, CDMA, GSM, and other wireless technologies.

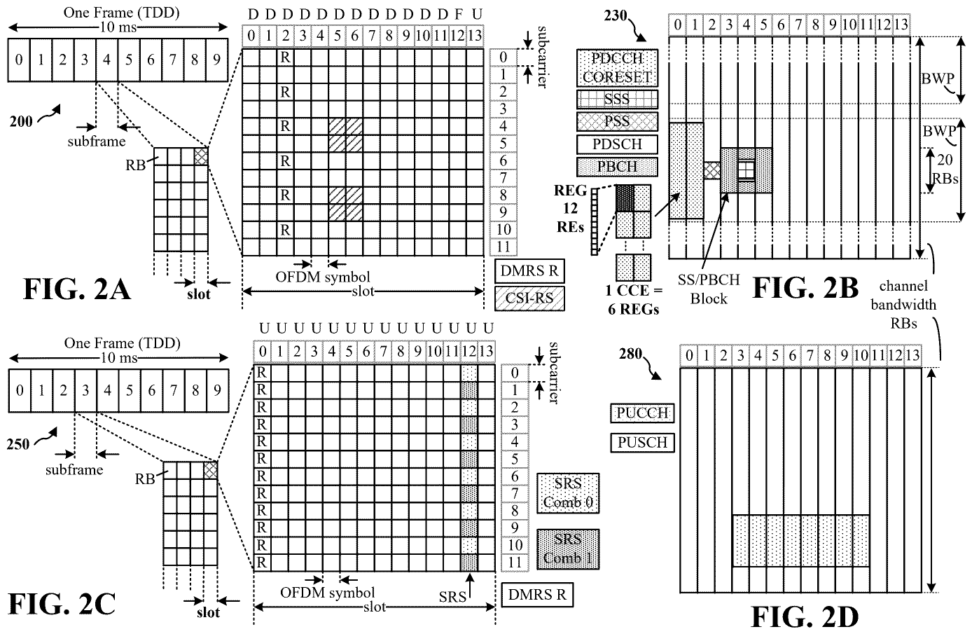

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

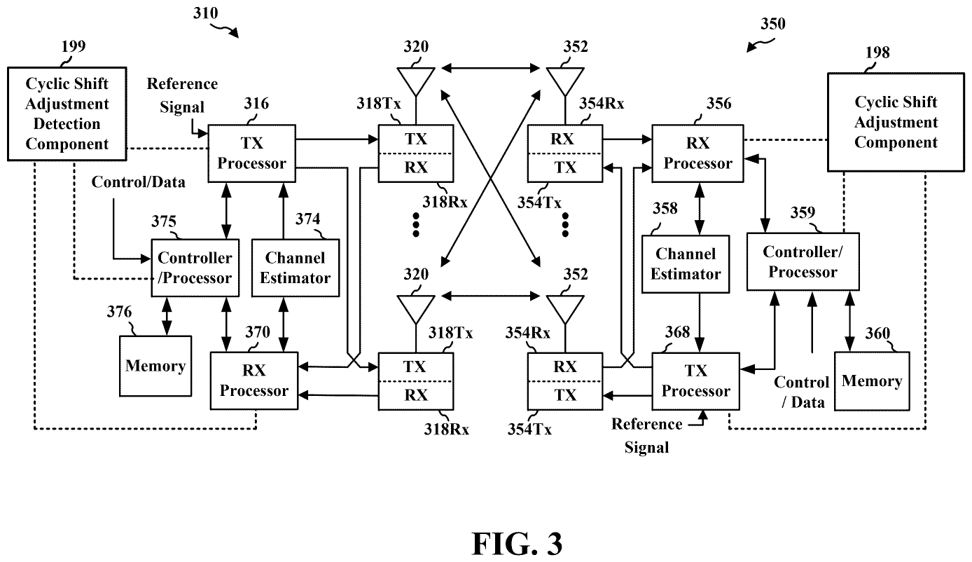

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the CS adjustment component 198 of FIG. 1.

At least one of the TX processor 316, the RX processor 370, and the controller/processor 375 may be configured to perform aspects in connection with the CS adjustment detection component 199 of FIG. 1.

In some aspects of wireless communication, for a random access, or initial access, procedure between a UE and a base station, the UE may receive information from a base station indicating a set of ROs (e.g., sets of time-and-frequency resources available for transmitting messages associated with the RACH procedure) and associated preambles for the RACH procedure. In some aspects, the ROs and associated preambles may be indicated in system information. To initiate the RACH procedure, the user may randomly select a preamble from a plurality of preambles associated with an RO (e.g., the set of preambles indicated in the information from the base station) and transmit a first message of the RACH procedure (which may be referred to as a msg1, msg 1, Msg1, or Msg 1) using the selected preamble via the RO. The selected preamble, in some aspects, may be selected from the set of preambles indicated by the system information received from the base station and may be based on a root of the sequence and CS value that can be used to differentiate between different first messages sent by different users (e.g., devices or UEs) via, in, or associated with, a same RO.

The base station may detect the first message and transmit a second message of the RACH procedure (which may be referred to as a msg2, msg 2, Msg2, or Msg 2) based on the detected preamble. The second message of the RACH procedure, in some aspects, may include an allocation of resources for a third message (which may be referred to as a msg3, msg 3, Msg3, or Msg 3) of the RACH procedure from the UE. In some aspects, there may be restrictions for allocating resources for the third message for certain users (e.g., based on a capability of a UE or wireless device performing the RACH procedure). For example, one or more BW or other restrictions may be applied for one or more classes of reduced capability (eRedCap) devices (e.g., eRedCap users).

For example, addition to higher capability devices wireless communication may support reduced capability devices. Among others, examples of higher capability devices include premium smartphones, V2X devices, URLLC devices, eMBB devices, etc. Among other examples, reduced capability devices may include wearables, industrial wireless sensor networks (IWSN), surveillance cameras, low-end smartphones, etc. For example, NR communication systems may support both higher capability devices and reduced capability devices. A reduced capability device may be referred to as an NR light device, a RedCap UE, an eRedCap UE, a low-tier device, a lower tier device, etc. In some examples, a reduced capability UE may have a reduced uplink transmission power compared to a higher capability UE. As another example, a reduced capability UE may have reduced transmission bandwidth or reception bandwidth than other UEs. As a further example, a reduced capability UE may have a reduced number of reception antennas in comparison to other UEs. For instance, a reduced capability UE may have only a single receive antenna and may experience a lower equivalent receive signal to noise ratio (SNR) in comparison to higher capability UEs that may have multiple antennas. Reduced capability UEs may also have reduced computational complexity than other UEs.

Knowledge of the features and/or capabilities of the UE or wireless device performing the RACH procedure may be used to allocate resources that are supported or compatible with a particular device. However, before an initial attachment or access, there are challenges associated with indicating the capabilities of the wireless device and/or UE performing the RACH procedure. In some aspects, a few bits of information may be carried in the preamble selection associated with the first msg (e.g., PRACH msg1) based on sequence splitting, where the PRACH sequences (sometimes referred to as preamble sequences) are split (or partitioned) into multiple groups, with each group representing or being associated with a certain PRACH configuration (e.g., a configuration for the RACH procedure associated with a UE and/or device capability or class). In some aspects, a partitioning of PRACH, or preamble, sequences may increase collisions within each group. The likelihood of a collision, in some aspects, may increase as the number of partitions increases, e.g., as the number of PRACH configurations that may be indicated by the selection of a preamble sequence from a particular preamble sequence partition increases.

Various aspects relate generally to a technique for transmitting a small number of bits of information over a first message (e.g., msg1) for an eRedCap UE. Some aspects more specifically relate to a technique to transmit a small amount of information (e.g., one or more bits of information) using an additional msg1 (e.g., a special msg1) transmission utilizing CS dithering (e.g., a CS adjustment or shift). In some aspects, the amount of CS dithering, or adjustment may be detected by a receiving base station and be mapped to, or used to identify, a class of UE or a UE capability. In some examples, a wireless device may be configured to transmit, via a first set of resources associated with a first RO, a first random access message (Msg 1) using a first preamble sequence, transmit, via a second set of resources associated with a second RO, an additional first random access message (additional Msg 1) using a second preamble sequence associated with a first cyclic shift value that indicates support for a capability of the UE, where the additional Msg 1 is based on the Msg 1, and receive a second random access message (Msg 2) based on the Msg 1 and the additional Msg 1. In certain aspects, a network node (e.g., a base station) may be configured to receive, from a UE via a first set of resources associated with a first RO, a first random access message (Msg 1) using a first preamble sequence, receive, from the UE via a second set of resources associated with a second RO, an additional first random access message (additional Msg 1) using a second preamble sequence associated with a first cyclic shift value that indicates support for a capability of the UE, where the additional Msg 1 is based on the Msg 1, and transmit, to the UE, a second random access message (Msg 2) based on the Msg 1 and the additional Msg 1.

A UE may use a random access procedure in order to communicate with a base station. For example, the UE may use the random access procedure to request an RRC connection, to re-establish an RRC connection, resume an RRC connection, etc. Random Access Procedures may include two different random access procedures, e.g., the UE may use Contention Based Random Access (CBRA) that may be performed when a UE is not synchronized with a base station, and a Contention Free Random Access (CFRA) may be applied, e.g., when the UE was previously synchronized to a base station. Both the procedures include transmission of a random access preamble from the UE to the base station. In CBRA, a UE may randomly select a random access preamble sequence, e.g., from a set of preamble sequences. As the UE randomly selects the preamble sequence, the base station may receive another preamble from a different UE at the same time. Thus, CBRA provides for the base station to resolve such contention among multiple UEs. In CFRA, the network may allocate a preamble sequence to the UE rather than the UE randomly selecting a preamble sequence. This may help to avoid potential collisions with a preamble from another UE using the same sequence. Thus, CFRA is referred to as “contention free” random access.

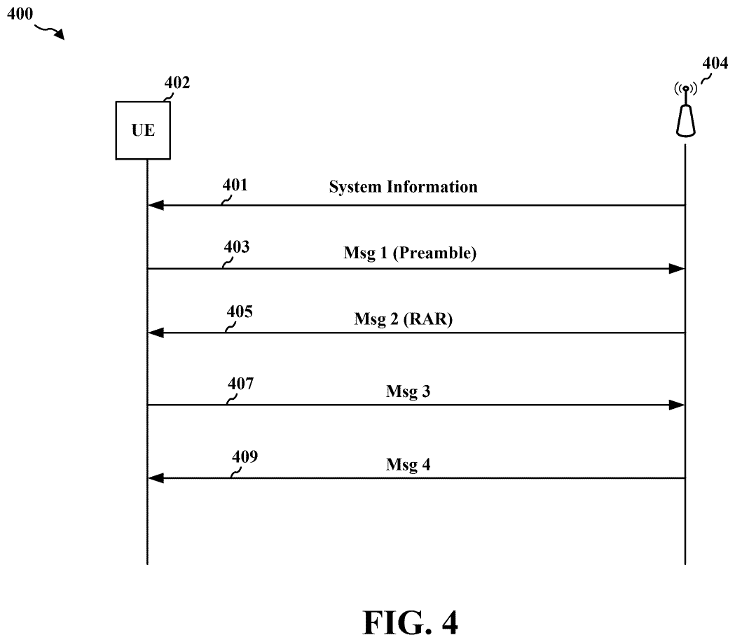

FIG. 4 illustrates example aspects of a random access procedure 400 between a UE 402 and a base station 404. The UE 402 may initiate the random access message exchange by sending, to the base station 404, a first random access message 403 (e.g., Msg 1) including a preamble in a RO. Prior to sending the first random access message 403, the UE may obtain random access parameters, e.g., including preamble format parameters, time and frequency resources, parameters for determining root sequences and/or cyclic shifts for a random access preamble, etc., e.g., in system information 401 from the base station 404. The preamble may be transmitted with an identifier, such as a Random Access RNTI (RA-RNTI). The UE 402 may randomly select a random access preamble sequence, e.g., from a set of preamble sequences. If the UE 402 randomly selects the preamble sequence, the base station 404 may receive another preamble from a different UE at the same time. In some examples, a preamble sequence may be assigned to the UE 402.

The base station responds to the first random access message 403 by sending a second random access message 405 (e.g. Msg 2) using PDSCH and including a random access response (RAR). The RAR may include, e.g., an identifier of the random access preamble sent by the UE, a time advance (TA), an uplink grant for the UE to transmit data, cell radio network temporary identifier (C-RNTI) or other identifier, and/or a back-off indicator. Upon receiving the RAR (in the second random access message 405), the UE 402 may, based on the uplink grant included in the second random access message 405, transmit a third random access message 407 (e.g., Msg 3) to the base station 404, e.g., using PUSCH, that may include a RRC connection request, an RRC connection re-establishment request, or an RRC connection resume request, depending on the trigger for the initiating the random access procedure. The base station 404 may then complete the random access procedure by sending a fourth random access message 409 (e.g., Msg 4) to the UE 402, e.g., using PDCCH for scheduling and PDSCH for the message. The fourth random access message 409 may include a random access response message that includes timing advance information, contention resolution information, and/or RRC connection setup information. The UE 402 may monitor for PDCCH, e.g., with the C-RNTI. If the PDCCH is successfully decoded (or detected), the UE 402 may also decode PDSCH. The UE 402 may send HARQ feedback for any data carried in the fourth random access message. If two UEs sent a same preamble at 403, both UEs may receive the RAR leading both UEs to send a third random access message 407. The base station 404 may resolve such a collision by being able to decode the third random access message from only one of the UEs and responding with a fourth random access message to that UE. The other UE, which did not receive the fourth random access message 409, may determine that random access did not succeed and may re-attempt random access. Thus, the fourth message may be referred to as a contention resolution message. The fourth random access message 409 may complete the random access procedure. Thus, the UE 402 may then transmit uplink communication and/or receive downlink communication with the base station 404 based on the fourth random access message 409.

In order to reduce latency or control signaling overhead, a single round trip cycle between the UE and the base station may be achieved in a 2-step RACH process. Aspects of Msg 1 and Msg 3 may be combined in a single message, e.g., which may be referred to as Msg A. The Msg A may include a random access preamble, and may also include a PUSCH transmission, e.g., such as data. The MsgA preambles may be separate from the four step preambles, yet may be transmitted in the same ROs as the preambles of the four step RACH procedure or may be transmitted in separate ROs. The PUSCH transmissions may be transmitted in PUSCH occasions (POs) that may span multiple symbols and PRBs. After the UE transmits the Msg A, the UE may wait for a response from the base station. Additionally, aspects of the Msg 2 and Msg 4 may be combined into a single message, which may be referred to as Msg B.

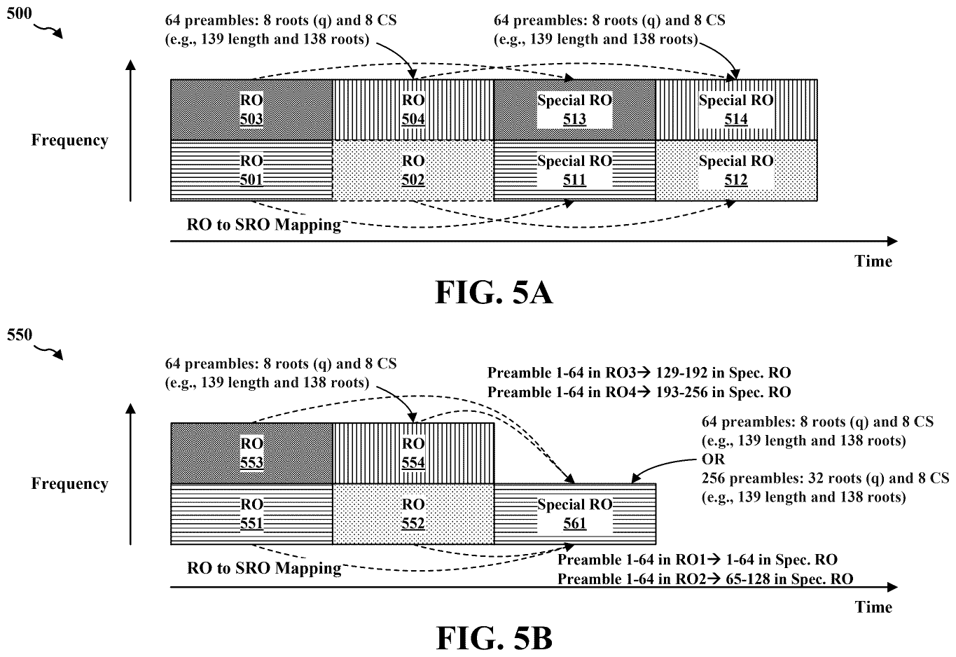

FIG. 5A is a diagram 500 illustrating a mapping between a set of ROs associated with [0084] first random access messages of a random access procedure and a set of additional ROs associated with additional first random access messages of the random access procedure indicating additional information relating to the transmitting device in accordance with some aspects of the disclosure. Diagram 500 illustrates that a first set of ROs (e.g., including RO 501, RO, 502, RO 503, and RO 504) may each be associated with a set of time-and-frequency resources, where the set of time-and-frequency resources may be used to transmit the first random access message (e.g., msg1) of the random access procedure. Each RO, in some aspects, may be associated with a set of preambles. The set of preambles, in some aspects, may be the same for each RO (e.g., may use the same root sequences and cyclic shifts) or may be different across ROs.

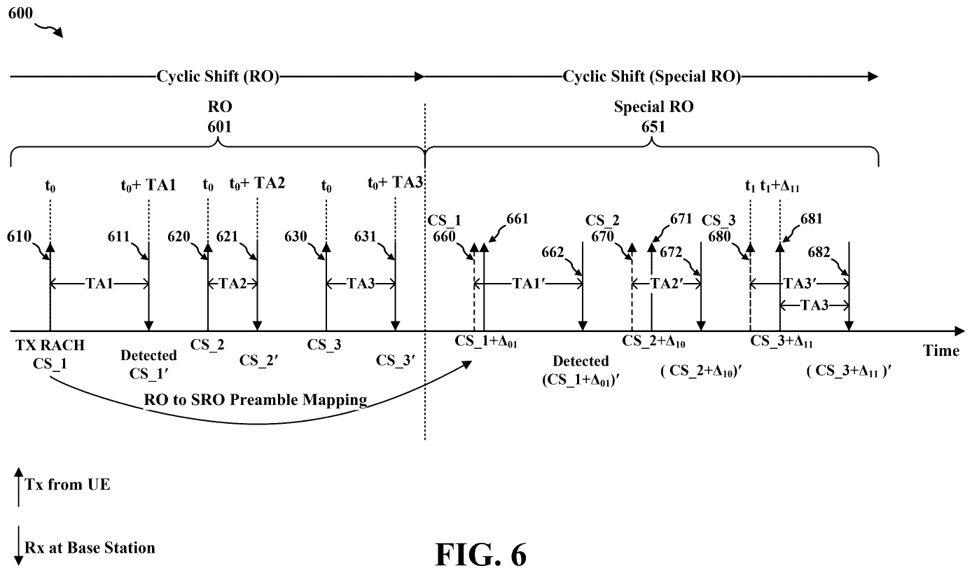

In some aspects, each RO in the first set of ROs may be mapped to a different (or unique) corresponding additional RO in the set of additional ROs (e.g., including special RO 511, special RO, 512, special RO 513, and special RO 514). The preambles associated with a particular RO in the first set of ROs may be the same as, or different from, the preambles associated with a particular corresponding additional RO in the set of additional ROs to which the particular RO in the first set of ROs is mapped. In some aspects, there may be a one-to-one mapping between preambles associated with the particular RO and the particular corresponding additional RO whether they use the same set of preambles or a different set of preambles. In some aspects, the number of preambles may be larger (e.g., based on a larger number of sequence roots) in the particular corresponding additional RO to allow for a same cyclic shift distance (N_{CS}) between preambles adjusted to indicate additional information as will be described below in relation to at least FIGS. 6-8. The additional ROs, in some aspects, may be referred to as special ROs or supplemental ROs and the additional first random access messages may be referred to as special Msg1 transmission or a supplemental first random access messages to indicate that the additional first random access messages associated with the additional ROs are used for a different purpose (e.g., to provide additional and/or supplemental information regarding support for a capability of the UE) from the first random access messages associated with the first set of ROs. The special Msg1 transmission is not a Msg1 repetition, as it provides additional information about the capability of the UE when considered together with the Msg 1 transmission.

FIG. 5B is a diagram 550 illustrating a mapping between a set of ROs associated with first random access messages of a random access procedure and an additional RO associated with additional first random access messages of the random access procedure indicating additional information relating to the transmitting device in accordance with some aspects of the disclosure. Diagram 550 illustrates that a first set of ROs (e.g., including RO 551, RO, 552, RO 553, and RO 554) may each be associated with a set of time-and-frequency resources, where the set of time-and-frequency resources may be used to transmit the first random access message (e.g., msg1) of the random access procedure. Each RO, in some aspects, may be associated with a set of preambles. The set of preambles, in some aspects, may be the same for each RO (e.g., may use the same root sequences and cyclic shifts) or may be different across ROs.

In some aspects, each RO in the first set of ROs may be mapped to one of a set of corresponding additional ROs in a set of additional ROs. Diagram 550 illustrates the case of a single-member set of additional ROs (e.g., including special RO 561) to which four ROs in the first set of ROs are mapped. In some aspects, the set of additional ROs may include two additional ROs and two ROs in the first set of ROs may be mapped to each additional RO in the set of additional ROs. As described above, the preambles associated with a particular RO in the first set of ROs may be the same as, or different from, the preambles associated with a particular corresponding additional RO in the set of additional ROs to which the particular RO in the first set of ROs is mapped. Accordingly, when using a same set of preambles and for the set of “unique” first messages that may be sent via the first set of ROs (e.g., first messages that can be identified by a combination of an associated RO and a preamble), there may be a many-to-one mapping between the set of unique first messages and the set of unique additional first messages. It is understood that, even for a many-to-one mapping, each first message is mapped to a particular preamble (e.g., a same preamble or a different, known, preamble).

In some aspects, the number of preambles associated with the additional RO (or set of additional ROs) may be large enough (e.g., may be associated with a larger number of root sequences and/or cyclic shifts) that there is a one-to-one mapping between the set of unique first messages and the set of unique additional first messages. For example, diagram 550 illustrates that each RO in the first set of ROs may be associated with a same, or different, set of 64 preambles (e.g., based on 8 sequence roots and 8 cyclic shift values associated with a sequence length of 139 and each indexed from 1-64) while the additional RO (e.g., special RO 561) is associated with a set of 256 preambles such that the preambles associated with the additional RO may be divided into subsets of preambles each corresponding to preambles associated with different ROs in the first set of ROs. For example, preambles 1-64 (e.g., based on some known indexing scheme and/or algorithm) associated with a first RO (e.g., RO 551) may be mapped to preambles 1-64 associated with the additional RO, preambles 1-64 associated with a second RO (e.g., RO 552) may be mapped to preambles 65-128 associated with the additional RO, preambles 1-64 associated with a third RO (e.g., RO 553) may be mapped to preambles 129-192 associated with the additional RO, and preambles 1-64 associated with a fourth RO (e.g., RO 554) may be mapped to preambles 193-256 associated with the additional RO.

FIG. 6 is a diagram 600 illustrating the use of the additional first random access message to transmit additional information in accordance with some aspects of the disclosure. While FIGS. 6-8 illustrate a time axis with different preambles sequences spaced in time, the time axis may be understood to apply within a set of related transmissions and/or receptions and/or may apply between, e.g., the RO 601 and the special RO 651, but in some aspects may not apply between different sets of related transmissions and/or receptions. Within an RO, a cyclic shift axis is depicted aligned with the time axis as different cyclic shifts may be interpreted as, equivalent to, or associated with, different shifts in a transmission time (or an apparent transmission time). For example, each related set of preamble transmission and preamble reception within a same RO may include a preamble transmission and a preamble reception. The preamble transmission may be transmitted at a time “to” (as measured at a transmitting device) and a lateral distance in the diagram between the transmitted preamble and the received preamble within a related set may represent a time (e.g., associated with a timing advance value as discussed below). Additionally, lateral space between different sets of preamble transmission and preamble reception may represent a cyclic shift (e.g., a different preamble sequence) where an additional cyclic shift may be interpreted as a shift in time as discussed below. In some aspects, a user (e.g., a wireless device or UE) may transmit additional information (e.g., the information regarding the support for a UE capability, a class of UE, a type of UE, a mode of operation at the UE, a capability of the UE, etc.) associated with a first random access message associated with a particular RO (e.g., a legacy RO, such as RO 601). The additional information may be indicated by altering the transmitted CS of a preamble sequence (e.g., a PRACH preamble, PRACH preamble sequence, random access preamble, or random access preamble sequence) in an additional first random access message in the additional (or special) RO (e.g., special RO 651).

In some aspects, a user (e.g., a first UE, a second UE, or a third UE) may first transmit regular msg1 in a RO for TA computation at the base station (e.g., a gNB). For example, in the RO 601, a first UE may transmit a first, first random access message (e.g., a first Msg 1 610) associated with a first CS (“CS_1”), a second UE may transmit a second, first random access message (e.g., a second Msg1 620) associated with a second CS (“CS_2”), and a third UE may transmit a third, first random access message (e.g., a third Msg1 630) associated with a third CS (“CS_3”). While illustrated as being transmitted at different times for clarity, each of the first Msg1 610, the second Msg1 620, and the third Msg1 630 may be transmitted at approximately the same time “to” (e.g., in association with a same time-and-frequency resource identified based on system information provided by the base station, in an SSB) such that they overlap in time. The base station may receive the first random access messages from the different users (e.g., a first received first random access message (e.g., a first received Msg1 611), a second received first random access message (e.g., a second received Msg1 621), and a third received first random access message (e.g., a third received Msg1 631)). In some aspects, the base station may be able to distinguish the different overlapping first random access messages based on the different preamble sequences used for the different first random access messages and/or based on different reception times (e.g., based on different TAs) of the received first random access messages. The base station may, based on an indication of the randomly selected preamble sequence (e.g., one of CS_1, CS_2, or CS_3) and a detected cyclic shift (e.g., one of CS_1′, CS_2′, or CS_3′ for a corresponding one of the first received Msg1 611, the second received Msg1 621, or the third received Msg1 631), determine a TA (e.g., one of TA1, TA2, or TA3) for a corresponding UE (e.g., one of the first UE, the second UE, or the third UE).

In a subsequent additional RO (e.g., special RO 651), the user (e.g., the first UE, the second UE, or the third UE) may then transmit an additional first random access message (e.g., a special msg1 such as a first additional first random access message 661, a second additional first random access message 671, a third additional first random access message 681) with an appropriate cyclic shift based on the information to be transmitted (e.g., a total cyclic shift carrying the information or a base cyclic shift and an additional cyclic shift carrying the information). In some aspects, as discussed above in relation to FIGS. 5A and 5B, the number of preambles (or preamble sequences) for the additional first random access message (e.g., the special msg1) is the same as the number of preambles (or preamble sequences) for the first random access message (e.g., the msg1) transmission. Similarly, as discussed above in relation to FIGS. 5A and 5B, in some aspects, there is a one-to-one mapping between the RO associated with the first random access message (e.g., a regular, or legacy, RO) and the additional RO associated with the additional first random access message (e.g., an additional, or special, RO) and/or a one-to-one mapping between the preamble sequences associated with the RO associated with the first random access message and the preamble sequences associated with the additional RO(s). In some aspects, a cyclic shift distance between the (base, or pre-adjustment) preamble sequences (N_{CS}′) for the additional first random access message (e.g. the special msg1) transmissions may be configured to be the cyclic shift distance (N_{CS}) between the preamble sequences for the first random access messages plus a value based on the amount of information that may be carried by the additional first random access message (e.g., 2\hat{ }(number of information bits to be transmitted)−1, or (minimum cyclic shift distance)*(number of classes that can be indicated), etc.). In some aspects, a minimum cyclic shift distance may be maintained between each candidate (or post-adjustment) preamble sequence that may be associated with an additional first random access message transmitted in association with the additional RO.

The user may select the preamble sequence for the additional first random access message (e.g., a special msg1) transmission based on the one-to-one mapping, and apply a CS dithering (e.g., a CS adjustment from the “base” preamble sequence identified by the one-to-one mapping) on the transmitted preamble sequence based on the information to be transmitted. If, for example, the additional first random access message is configured to carry two bits of information, the CS dithering, or adjustment, may be based on a mapping from the possible bit values and a CS dithering value (see Table 2).

TABLE 2
Information bits to CS Dithering Mapping

| Information bits | 00 | 01 | 10 | 11 |
|---|---|---|---|---|
| CS Dithering | 0 | 1 | 2 | 3 |

For example, the first Msg1 610 may map to a preamble sequence associated with a first (“base”) cyclic shift (“CS_1” 660) and, based on the additional information (e.g., bit values “01” mapping to a CS dithering value of Δ₀₁) to be included in the first additional first random access message regarding the first UE, a preamble sequence based on an adjusted cyclic prefix (e.g., “CS_1+Δ01”) may be used to transmit a first additional first random access message 661. The first additional first random access message 661 may be received as a first received additional first random access message (e.g., a first received additional Msg1 662). The base station may calculate an additional TA (e.g., TA1′) based on the “base” cyclic shift (“CS_1” 660) and the first received additional Msg1 662. Assuming that the TA has not changed between the RO 601 and the special RO 651, the base station may identify the CS dithering value based on the different between the TA (e.g., TA1) calculated for the first Msg1 610 and the first received Msg1 611 and the additional TA (e.g., TA1′) based on the “base” cyclic shift (“CS_1” 660) and the first received additional Msg1 662.

Similarly, the second Msg1 620 may map to a preamble sequence associated with a second (“base”) cyclic shift (“CS_2” 670) and, based on the additional information (e.g., bit values “10” mapping to a CS dithering value of 410) to be included in the second additional first random access message regarding the second UE, a preamble sequence based on an adjusted cyclic prefix (e.g., “CS_2+Δ₁₀”) may be used to transmit a second additional first random access message 671. The second additional first random access message 671 may be received as a second received additional first random access message (e.g., a second received additional Msg1 672). The base station may calculate an additional TA (e.g., TA2′) based on the “base” cyclic shift (“CS_2” 670) and the second received additional Msg1 672. Assuming that the TA has not changed between the RO 601 and the special RO 651, the base station may identify the CS dithering value based on the different between the TA (e.g., TA2) calculated for the second Msg1 620 and the second received Msg1 621 and the additional TA (e.g., TA2′) based on the “base” cyclic shift (“CS_2” 670) and the second received additional Msg1 672.

Similarly, the third Msg1 620 may map to a preamble sequence associated with a third (“base”) cyclic shift (“CS_3” 680) and, based on the additional information (e.g., bit values “11” mapping to a CS dithering value of Δ₁₁) to be included in the third additional first random access message regarding the third UE, a preamble sequence based on an adjusted cyclic prefix (e.g., “CS_3+Δ₁₁”) may be used to transmit a third additional first random access message 681. The third additional first random access message 681 may be received as a third received additional first random access message (e.g., a third received additional Msg1 682). The base station may calculate an additional TA (e.g., TA3′) based on the “base” cyclic shift (“CS_3” 680) and the third received additional Msg1 682. Assuming that the TA has not changed between the RO 601 and the special RO 651, the base station may identify the CS dithering value based on the different between the TA (e.g., TA3) calculated for the third Msg1 630 and the third received Msg1 631 and the additional TA (e.g., TA3′) based on the “base” cyclic shift (“CS_3” 680) and the third received additional Msg1 682. As illustrated, the CS dithering value of Δ₁₁, in some aspects, may be interpreted as, or mimic, a shift in a transmission time, where the actual transmission time may be “t₁” and the apparent transmission time (based on the assumption of a same TA, e.g., TA3) may be “t₁+Δ₁₁”.

In some aspects, to refrain from introducing additional collisions, a one-to-one mapping may be configured between the preamble sequences associated with the first set of ROs (e.g., the regular ROs) and the preamble sequences associated with the additional ROs (e.g., the special ROs). A one-to-one mapping, in some aspects, may be associated with the number of additional ROs being the same as the number of ROs in the first set of ROs (e.g., the regular ROs) as described in relation to FIG. 5A. To reduce the resource allocation for the additional RO(s) (e.g., the special ROs), a number of preamble sequences associated with the additional RO(s) (e.g., the special RO(s)) may be much higher than number of preamble sequences associated with the ROs in the first set of ROs (e.g., one, multiple, or all, of the regular ROs associated with one additional RO or set of additional ROs). For example, as a base station (or gNB) searches for the paths (or additional first random access messages) in the additional ROs (e.g., the special ROs) around, or based on, the already detected paths (or already detected first random access messages) in ROs in the first set of ROs (e.g., in a regular RO), false alarms may not be an issue, and a higher number of preamble sequences may be allocated for the additional ROs (e.g., the special ROs) to improve resource utilization (e.g., to reduce the time-and-frequency resources allocated to the additional RO). Accordingly, due to the higher number of preamble sequences associated with the additional RO (e.g., the special RO), multiple ROs in the first set of ROs (e.g., the regular ROs) may be mapped to the same additional RO (e.g., the same special RO) as described in relation to FIG. 5B.

In some aspects, a many-to-one mapping may be configured between the preamble sequences associated with the ROs in the first set of ROs (e.g., the preambles for the regular ROs) to the preamble sequences associated with the additional RO(s) (e.g., the preambles for the special RO) as discussed in relation to FIG. 5B. In some aspects, multiple preamble sequences associated with the same RO in the first set of ROs (e.g., the same regular RO) or across ROs in the first set of ROs (e.g., across multiple regular ROs) may be assigned (or mapped) to the same preamble sequence in an additional RO (e.g., an special RO). Based on the many-to-one mapping, there may be a collision in the additional RO (e.g., the special RO) between additional first random access messages that did not occur between the first random access messages mapped to the additional first random access messages. For example, if multiple users select preamble sequences for first random access messages associated with different ROs in the first set of ROs (e.g., for a Msg1 in a regular RO) that are mapped, or correspond, to a same preamble sequence for an additional first message associated with the additional RO (e.g., a same special RO preamble) a collision may occur in the additional RO that did not occur between the related first random access messages.

A rate of such additional collisions may depend on the user activity (e.g., the number of devices attempting initial access and a frequency of the transmissions). Even in the case of a collision between additional first random access messages, a base station (or gNB) may still be able to recover a user's information (e.g., the additional information included in the additional first random access message) if the arrival paths corresponding to multiple users spread in time or are distinguishable in other ways (e.g., a received power).

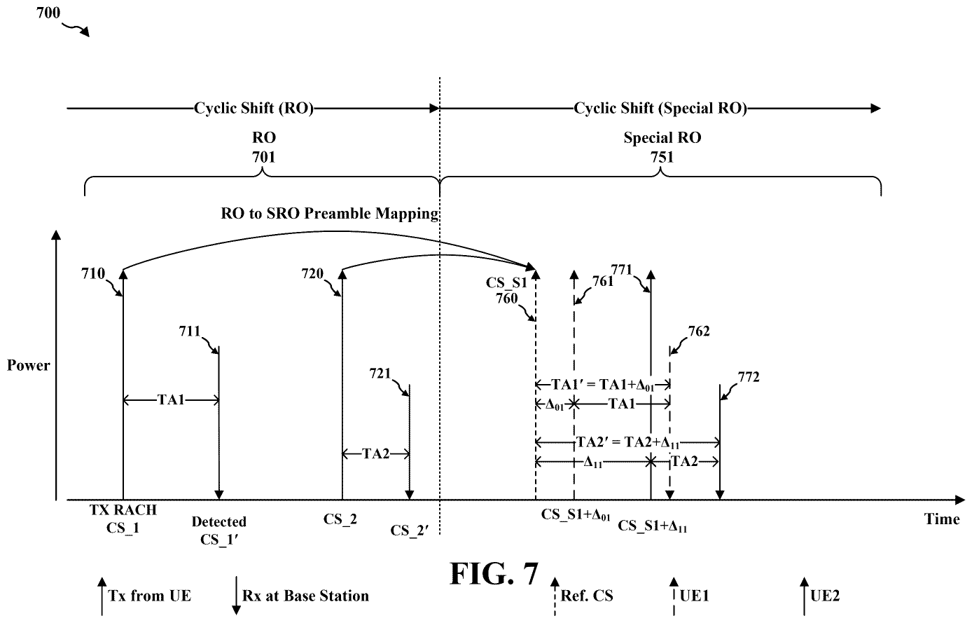

FIG. 7 is a diagram 700 illustrating a first technique for collision handling in accordance with some aspects of the disclosure. As discussed above in relation to FIG. 6, the time axis in diagram 700 may be understood to apply within a set of related transmissions and/or receptions and/or may apply between the RO 701 and the special RO 751, but in some aspects may not apply between different sets of related transmissions and/or receptions. Diagram 700 illustrates that, in a first RO 701 (e.g., an RO in the first set of ROs of FIG. 5B) a first UE may transmit a first, first random access message (e.g., a first Msg1 710) and a second UE may transmit a second, first random access message (e.g., a second Msg1 720). The transmitted power of the first Msg1 710 and the second Msg1 720, in some aspects, may different or the same. A base station may receive a first received first random access message (e.g., a first received Msg1 711) with a first received power and a second received first random access message (e.g., a second received Msg1 721) with a second received power. The base station may calculate a first TA (e.g., TA1) and a second TA (e.g., TA2) for a corresponding UE (e.g., one of the first UE or the second UE) based on an indication of the randomly selected preamble sequence (e.g., one of CS_1 or CS_2) and a detected cyclic shift (e.g., one of CS_1′ or CS_2′ for a corresponding one of the first received Msg1 711 or the second received Msg1 721).

As illustrated in diagram 700, the first Msg1 710 and the second Msg1 720 may map to a same preamble sequence (“CS_S1” 760) in a same additional RO (e.g., special RO 751). However, the additional information included in the additional first random access message (e.g., encoded in the cyclic shift dithering associated with a transmitted first additional first random access message 761 or second additional first random access message 771) by the different UEs may be different. For example, the first UE may encode first information corresponding to a first CS dithering, or CS adjustment, value (Δ₀₁ or 1 CS) in a first received additional first random access message (e.g., a first received additional Msg1 762) while the second UE may encode second information corresponding to a second CS dithering, or CS adjustment, value (Δ₁₁ or 3 CS) in a second received additional first random access message (e.g., a second received additional Msg1 772).

Based on the timing alone (e.g., based on the combination of TA and CS dithering/adjustment), the base station may not be able to determine whether the first received additional Msg1 762 is associated with the first UE and a CS dithering, or CS adjustment, value (Δ₀₁ or 1 CS) or is associated with the second UE and a CS dithering, or CS adjustment, value (Δ10 or 2 CS). Similarly, based on the timing alone, the base station may not be able to determine whether the second received additional Msg1 772 is associated with the first UE and a CS dithering, or CS adjustment, value (Δ₁₀ or 2 CS) or is associated with the second UE and a CS dithering, or CS adjustment, value (Δ₁₁ or 3 CS). However, based on a third received power of the first received additional Msg1 762 being equal to (or closer to) the first received power of the first received Msg1 711 and a fourth received power of the second received additional Msg1 772 being equal to (or closer to) the second received power of the second received Msg1 721, the base station may be able to associate the first received additional Msg1 762 with the first UE and the second received additional Msg1 772 with the second UE. Once the first received additional Msg1 762 has been associated with the first UE and the second received additional Msg1 772 has been associated with the second UE, the base station may determine that the first UE is associated with the CS dithering, or CS adjustment, value (Δ₀₁ or 1 CS) and that the second UE is associated with the CS dithering, or CS adjustment, value (Δ₁₁ or 3 CS).

While the first random access messages (e.g., the first received Msg1 711 and the second received Msg1 721) did not collide, and separate resources can be allocated and indicated for both the first UE and the second UE, if, using the combination of the timing and the power, the association between the received additional first random access messages and the UEs may not reliably be determined, the base station may allocate resources to both UEs based on a lowest user configuration (e.g., a minimal supported UE capability) among the possible configurations or capabilities indicated by the CS dithering and/or CS adjustment. In some aspects, a subset of capabilities may be possible for each UE and the base station may allocate resources based on a lowest candidate user configuration. For example, in the context of diagram 700, the first UE was either associated with the CS dithering value of Δ₀₁/1 CS or Δ₁₀/2 CS, while the second UE was either associated with the CS dithering value of Δ₁₀/2 CS or Δ₁₁/3 CS and the base station can allocate resources for the first UE based on the lowest capability and/or configuration between the capabilities and/or configuration associated with the CS dithering values Δ₀₁/1 CS and Δ₁₀/2 CS and can allocate resources for the second UE based on the lowest capability and/or configuration between the capabilities and/or configuration associated with the CS dithering values Δ₁₀/2 CS or Δ₁₁/3 CS.

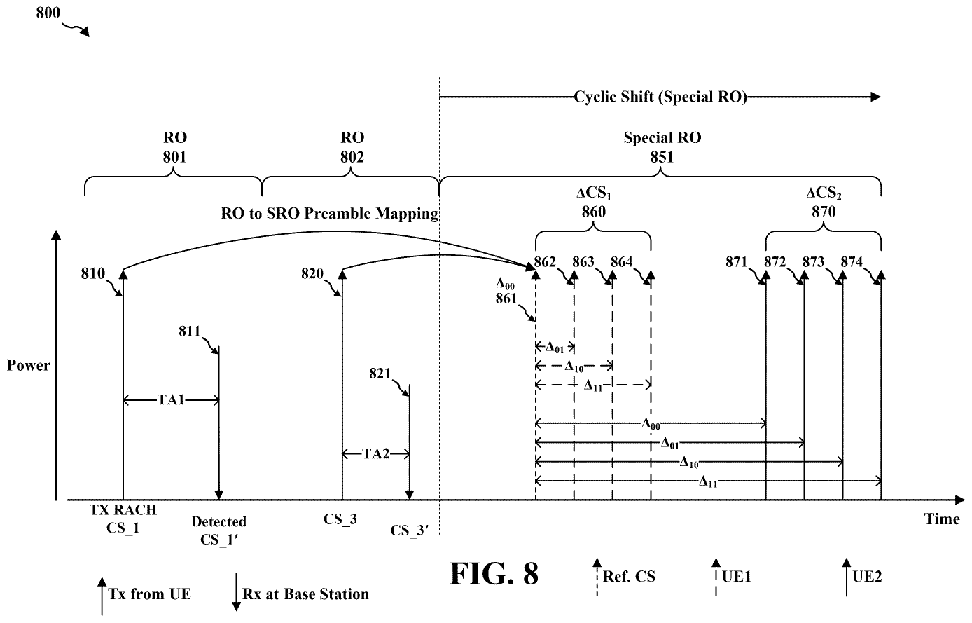

FIG. 8 is a diagram 800 illustrating a first technique for collision avoidance in accordance with some aspects of the disclosure. As discussed above in relation to FIG. 6, the time axis in diagram 800 may be understood to apply within a set of related transmissions and/or receptions and/or may apply between the RO 801, the RO 802, and the special RO 851, but in some aspects may not apply between different sets of related transmissions and/or receptions. Diagram 800 illustrates that, in a first RO 801 (e.g., a first RO, such as RO 551, in the first set of ROs of FIG. 5B) a first UE may transmit a first, first random access message (e.g., a first Msg1 810) and, in a second RO 802 (e.g., a second RO, such as RO 552, in the first set of ROs of FIG. 5B), a second UE may transmit a second, first random access message (e.g., a second Msg1 820). The transmitted power of the first Msg1 810 and the second Msg1 820, in some aspects, may be different or the same. A base station may receive a first received first random access message (e.g., a first received Msg1 811) with a first received power and a second received first random access message (e.g., a second received Msg1 821) with a second received power. The base station may calculate a first TA (e.g., TA1) and a second TA (e.g., TA2) for a corresponding UE (e.g., one of the first UE or the second UE) based on an indication of the randomly selected preamble sequence (e.g., one of CS_1 or CS_2) and a detected cyclic shift (e.g., one of CS_1′ or CS_2′ for a corresponding one of the first received Msg1 611 or the second received Msg1 621). While the technique discussed above using the power of the received additional first random access messages may be combined with the technique below, it will not be addressed below as it has already been explained above.

As illustrated in diagram 800, the first Msg1 810 and the second Msg1 820 may map to a same preamble sequence (e.g., a preamble sequence 861) associated with no CS dithering, or CS adjustment, in a same additional RO (e.g., special RO 851). However, the first RO 801 may be associated with a first set of CS dithering, or CS adjustment, values (e.g., ΔCS₁ 860) corresponding to a set of information capable of being indicated (e.g., a set of user configurations and/or supported UE capabilities) and the second RO 802 may be associated with a second set of CS dithering, or CS adjustment, values (e.g., ΔCS₂ 870) corresponding to the set of information capable of being indicated. For example, the first set of CS dithering, or CS adjustment, values (e.g., ΔCS₁ 860) may be associated with a first set of candidate preamble sequences including a preamble sequence 861 associated with a first CS dithering, or CS adjustment, value (Δ₀₀/0 CS), a preamble sequence 862 associated with a second CS dithering, or CS adjustment, value (Δ₀₁/1 CS), a preamble sequence 863 associated with a third CS dithering, or CS adjustment, value (Δ₁₀/2 CS), and a preamble sequence 864 associated with a fourth CS dithering, or CS adjustment, value (Δ₁₁/3 CS). Similarly, the second set of CS dithering, or CS adjustment, values (e.g., ΔCS₂ 870) may be associated with a second set of candidate preamble sequences including a preamble sequence 871 associated with a first CS dithering, or CS adjustment, value (Δ₀₀/6 CS), a preamble sequence 872 associated with a second CS dithering, or CS adjustment, value (Δ₀₁/7 CS), a preamble sequence 873 associated with a third CS dithering, or CS adjustment, value (Δ₁₀/8 CS), and a preamble sequence 874 associated with a fourth CS dithering, or CS adjustment, value (Δ₁₁/9 CS). While the example above describe two distinct sets of CS dithering, or CS adjustment, values (e.g., ΔCS₁ 860 and ΔCS₂ 870), additional sets of CS dithering, or CS adjustment, values may be used for more ROs in the first set of ROs mapped to a same additional RO. Additionally, while a spacing between CS dithering values or 1 CS and a space between different sets of CS dithering, or CS adjustment, values of 3 CS, are used in the examples above, in some aspects, the spacing between CS dithering values may be greater and/or the space between different sets of CS dithering, or CS adjustment, values may be less than or greater than 3 CS. In some aspects, using larger CS dithering, or CS adjustment, values (e.g., for the second set of CS dithering, or CS adjustment, values, ΔCS₂ 870) may be associated with an increase in the cyclic shift distance (N_{CS}′) between the preamble sequences for the additional first random access messages and/or associated with the additional ROs such that a cyclic shift distance between preamble sequences associated with different “base” preamble sequences is at least the cyclic shift distance (N_{CS}) between the preamble sequences for the first random access messages (e.g., the N_{CS}′ between “base” preamble sequences is at least N_{CS} plus a highest CS dithering, or CS adjustment, applied to the “base” preamble sequences).

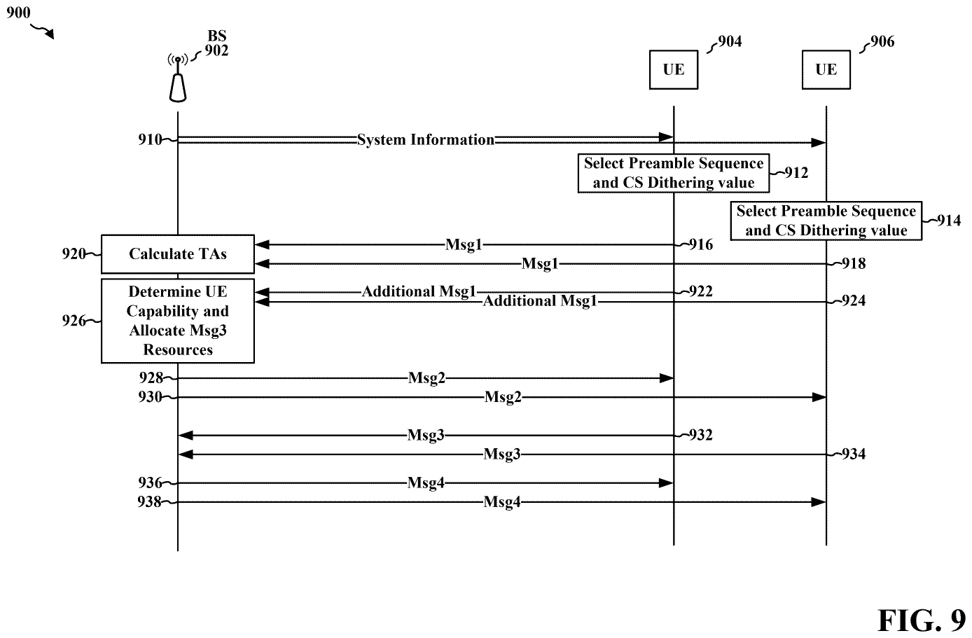

FIG. 9 is a call flow diagram 900 illustrating a method of wireless communication in accordance with some aspects of the disclosure. The method is illustrated in relation to a base station 902 (e.g., as an example of a network device or network node that may include one or more components of a disaggregated base station) in communication with UE 904 and UE 906 (e.g., as examples of a wireless device). The functions ascribed to the base station 902, in some aspects, may be performed by one or more components of a network entity, a network node, or a network device (a single network entity/node/device or a disaggregated network entity/node/device as described above in relation to FIG. 1). Similarly, the functions ascribed to the UE 904 and/or the UE 906, in some aspects, may be performed by one or more components of a wireless device supporting communication with a network entity/node/device. Accordingly, references to “transmitting” in the description below may be understood to refer to a first component of the base station 902 (or the UE 904) outputting (or providing) an indication of the content of the transmission to be transmitted by a different component of the base station 902 (or the UE 904). Similarly, references to “receiving” in the description below may be understood to refer to a first component of the base station 902 (or the UE 904) receiving a transmitted signal and outputting (or providing) the received signal (or information based on the received signal) to a different component of the base station 902 (or the UE 904).

The base station 902, may transmit, and UE 904 and UE 906 may receive, system information 910 indicating information for a random access procedure (e.g., an initial access procedure or RACH procedure). In some aspects, the system information 910 may include configuration information relating to, or identifying, ROs for first random access messages and additional first random access messages associated with the random access procedure. The configuration information, in some aspects, may include an indication of preamble sequences (e.g., sequence roots and cyclic shift values) associated with each RO and additional RO. In some aspects, the system information 910 may include an indication of a mapping (e.g., a one-to-one mapping or a many-to-one mapping) of ROs to additional ROs and/or preamble sequences associated with each RO to preamble sequences associated with an additional RO in a set of one or more additional ROs. The system information 910, in some aspects, may include a configuration for the CS dithering and/or CS adjustment such as the types of information that may be indicated and the mapping between CS dithering values and the specific information indicated by the CS dithering (or between specific information and a corresponding CS dithering value). In some aspects, the configuration of the ROs, the additional ROs, and the preamble sequence mapping may be at least partially pre-configured, or known, to the UE 904 and the UE 906.

Based on the system information 910 and/or additional transmission received from the base station 902 (e.g., synchronization signals such as those include in an SSB), the UE 904 may determine to initiate a random access procedure and, at 912, (randomly) select a first preamble sequence from a set of candidate preamble sequences associated with an RO (e.g., a first RO that has been selected or determined for transmission of a first random access message) and determine a corresponding (second) preamble sequence (e.g., based on a mapping as described above in relation to FIGS. 5A and/or 5B), an additional RO, and a CS dithering, or CS adjustment, value for an additional first random access message. Similarly, based on the system information 910 and/or additional transmission received from the base station 902, the UE 906 may determine to initiate a random access procedure and, at 914, (randomly) select a (third) preamble sequence from a set of candidate preamble sequences associated with an RO (e.g., a second RO that has been selected or determined for transmission of a first random access message) and determine a corresponding (fourth) preamble sequence (e.g., based on a mapping as described above in relation to FIGS. 5A and/or 5B), an additional RO, and a CS dithering, or CS adjustment, value for an additional first random access message.

Based on the selection at 912, the UE 904 may transmit, and the base station 902 may receive, the first random access message 916 (e.g., a first Msg1) using the first preamble sequence and via the resources associated with the first RO. Similarly, based on the selection at 914, the UE 906 may transmit, and the base station 902 may receive, the first random access message 918 (e.g., a second Msg1) using the third preamble sequence and via the resources associated with the second RO. In some aspects, the techniques and/or methods discussed below will apply when there is no collision between the first random access message 916 and the first random access message 918, e.g., when at least one of the first preamble sequence is different from the first preamble sequence or the second RO is different from the first RO. Based on the first random access message 916 and the first random access message 918, the base station may, at 920, calculate TA values for the UE 904 and the UE 906 (e.g., a first TA value for UE 904 and a second TA value for UE 906).

Based on the determination of the (second) preamble sequence, the additional RO, and the CS dithering, or CS adjustment, value at 912, the UE 904 may transmit, and the base station 902 may receive, the additional first random access message 922 (e.g., a first additional Msg1) using the second preamble sequence adjusted based on the determined CS dithering, or CS adjustment value and via the resources associated with the additional RO. Similarly, based on the determination of the (fourth) preamble sequence, the additional RO, and the CS dithering, or CS adjustment, value at 914, the UE 906 may transmit, and the base station 902 may receive, the additional first random access message 924 (e.g., a second additional Msg1) using the fourth preamble sequence adjusted based on the determined CS dithering, or CS adjustment value and via the resources associated with the additional RO. While it is possible that the additional ROs determined by different UEs or determined for different additional first random access messages may be different, we assume that the same additional RO is determined at both 912 and 914 to illustrate aspects of the method.

In some aspects, the base station may monitor for additional first random access messages based on first random access messages received in one or more ROs. For example, the base station may monitor for preamble sequences associated with additional ROs (e.g., the preamble sequences including candidate CS dithering and/or CS adjustment) to which received first random access messages (and their preamble sequences) are mapped. The base station, based on the TAs calculated at 920, and the received additional first random access messages 922 and 924 (e.g., the first additional Msg1 and the second additional Msg1), may, at 926, determine a UE capability associated with each of the UE 904 and the UE 906 and allocate (or determine an allocation of) resources for a third random access message of the random access procedure. For example, in some aspects, the base station, at 926, may associate the first random access message 916 with the additional first random access message 922 and associating the first random access message 918 with the additional first random access message 924 based on one or more of: a first timing advance value associated with the first random access message 916 and the additional first random access message 922 received from the UE 904 and a second timing advance value associated with the first random access message 918 and the additional first random access message 924 received from the UE 906, a first received power associated with the first random access message 916 and the additional first random access message 922 from the UE 904 and a second received power associated with the first random access message 918 and the additional first random access message 924 received from the UE 906, or a first set of CS dithering values associated with the first random access message 916 and the additional first random access message 922 from the UE 904 (e.g., based on being associated with the first RO) and a second set of CS dithering values associated with the first random access message 918 and the additional first random access message 924 received from the UE 906 (e.g., based on being associated with a second RO). For example, the determination at 926, in some aspects, may use any, or all, of the methods discussed above in relation to FIGS. 6-8.

In some aspects, the base station, at 926, may allocate, based on the additional first random access message 922 (e.g., based on the second preamble sequence adjusted based on the CS dithering value determined at 912), first resources for a third random access message (a first Msg3). The base station, at 926, may, in some aspects, allocate, based on the additional first random access message 924 (e.g., based on the fourth preamble sequence adjusted based on the CS dithering value determined at 914) second resources for a second Msg3. As described above, the resource allocation for the first Msg3 and the second Msg3 may be based on the information indicated by the CS dithering value. For example, the CS dithering value may be associated with a UE capability relating to a BW or other transmission characteristic (e.g., a transmission power, a duty cycle, a number of antennas, etc.) and the resource allocation may be determined so as to be compatible with the indicated UE capability and/or supported capabilities of the UE.

Based on the allocation of the resources at 926, the base station may transmit, and the UE 904 may receive, a second random access message 928 (e.g., a first Msg2) indicating the allocated resources (e.g., the resources allocated at 926). In some aspects, based on the allocation of the resources at 926, the base station may transmit, and the UE 906 may receive, a second random access message 930 (e.g., a second Msg2) indicating the allocated resources (e.g., the resources allocated at 926). Based on the second random access message 928, the UE 904 may transmit, and the base station 902 may receive, the first Msg3 932, and based on the second random access message 930, the UE 906 may transmit, and the base station 902 may receive, the second Msg3 934. Similarly, based on the first Msg3 932 and the second Msg3 934, the base station may transmit, and UE 904 and UE 906 may, respectively, receive, fourth random access message 936 (e.g., a first Msg4) and fourth random access message 938 (e.g., a second Msg4).

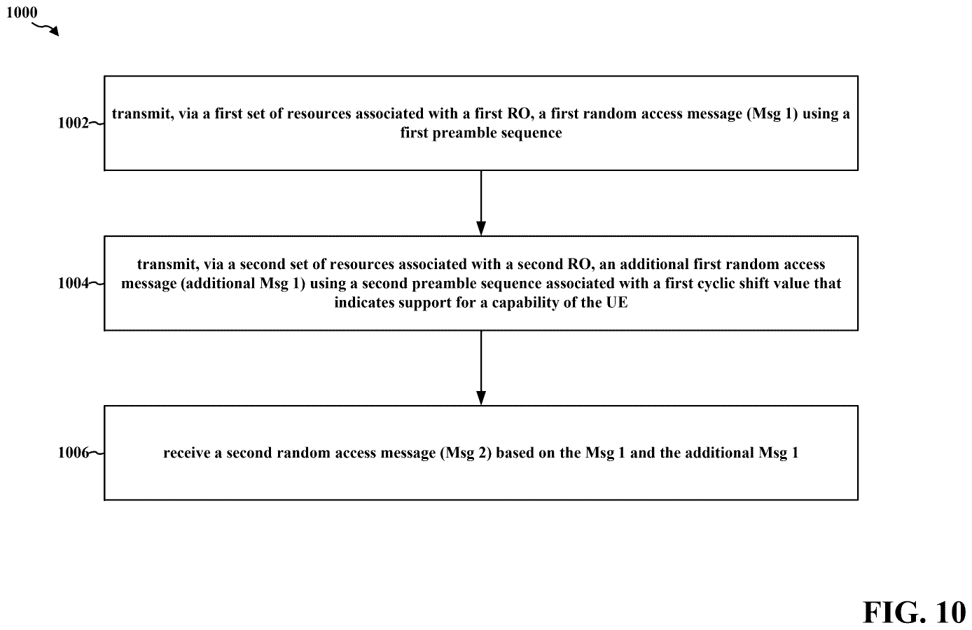

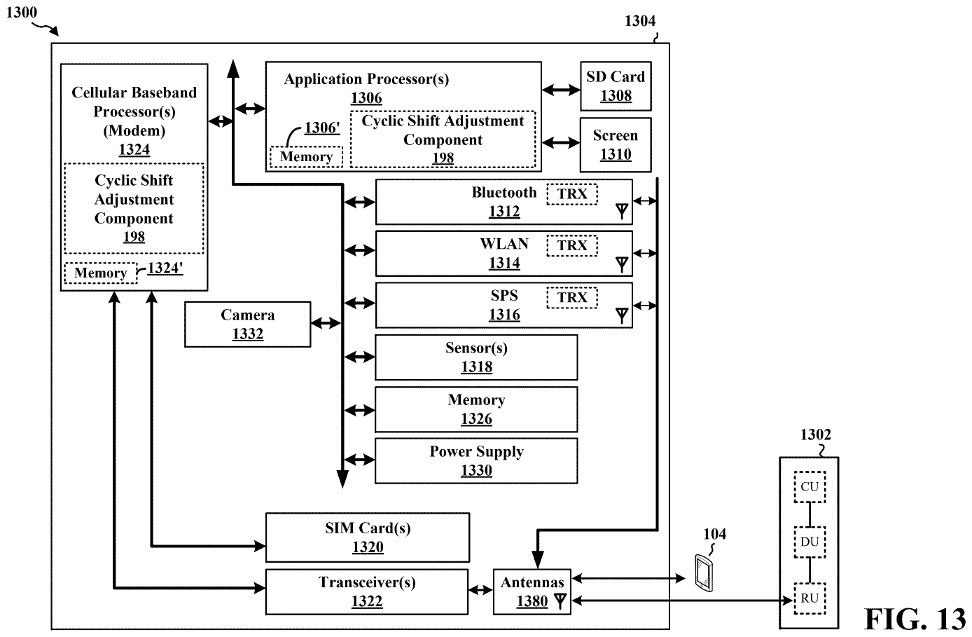

FIG. 10 is a flowchart 1000 of a method of wireless communication. The method may be performed by a wireless device such as a UE (e.g., the UE 104, 402, 904, 906; the apparatus 1304). At 1002, the UE may transmit, via a first set of resources associated with a first RO, a first random access message (Msg 1 or Msg1) using a first preamble sequence. For example, 1002 may be performed by application processor(s) 1306, cellular baseband processor(s) 1324, transceiver(s) 1322, antenna(s) 1380, and/or CS adjustment component 198 of FIG. 13. In some aspects, the first preamble sequence may be selected from a first set of preamble sequences associated with a first set of root indexes and a first set of cyclic shift values. For example, referring to FIGS. 4, 5A, 5B, and 6-9, the UE 402, the UE 904, or the UE 906 may transmit (e.g., via one of the ROs in the first set of ROs in either FIG. 5A or FIG. 5B) a first random access message 403, a first Msg1 610, a second Msg1 620, a first Msg1 710, a second Msg1 720, a first Msg1 810, a second Msg1 820, a first random access message 916, or a first random access message 918.

At 1004, the UE may transmit, via a second set of resources associated with a second RO, an additional first random access message (e.g., an additional Msg 1) using a second preamble sequence associated with a first cyclic shift value that indicates support for a capability of the UE. In some aspects, the additional Msg 1 is based on the Msg 1. The second RO, in some aspects, may be indicated for additional Msg 1 transmissions associated with prior Msg 1 transmissions in a single RO that corresponds to the first RO. In some aspects, a first set of preamble sequences, which are based on a first set of root indexes and a first set of cyclic shift values, are associated with both the first RO and the second RO. The second RO, in some aspects, may be indicated for additional Msg 1 transmissions associated with prior Msg 1 transmissions in any of a plurality of ROs, where the plurality of ROs includes the first RO. In some aspects, the first preamble sequence may be selected by the UE from a first set of preamble sequences including a first number of preamble sequences based on a first set of root indexes and a first set of cyclic shift values. In some aspects, the first set of preamble sequences is associated with each of the plurality of ROs, the plurality of ROs includes a second number of ROs, and the second preamble sequence is associated with one of: (1) a second set of preamble sequences associated with the second RO or (2) a third set of preamble sequences associated with the second RO. The second set of preamble sequences, in some aspects, may include a third number of preamble sequences based on a second set of root indexes and a second set of cyclic shift values, where the third number of preamble sequences is greater than or equal to the first number of preamble sequences multiplied by the second number of ROs, and where there is a one-to-one mapping from first preamble sequences in the first set of preamble sequences associated with each RO to second preamble sequences in the second set of preamble sequences. In some aspects, the third set of preamble sequences may include a fourth number of preamble sequences based on a third set of root indexes and a third set of cyclic shift values, where the fourth number of preamble sequences is smaller than the first number of preamble sequences multiplied by the second number of ROs, and where there is a many-to-one mapping from the first preamble sequences in the first set of preamble sequences associated with the plurality of ROs to third preamble sequences in the third set of preamble sequences. In some aspects, the first preamble sequence may be mapped to a corresponding preamble sequence in a second set of preamble sequences for the second RO associated with a second set of root indexes and a second set of cyclic shift values, where the corresponding preamble sequence is associated with a particular root index in the second set of root indexes and a particular cyclic shift value in the second set of cyclic shift values, and the second preamble sequence may be based on the particular root index and an applied cyclic shift value including a sum of the particular cyclic shift value and the first cyclic shift value, and where the first cyclic shift value is selected from a third set of cyclic shift values (e.g., a set of cyclic shift values, or CS dithering values, used to indicate the support for the capability of the UE). The first set of preamble sequences, in some aspects, may be associated with a first cyclic shift distance between first preamble sequences in the first set of preamble sequences and the second set of preamble sequences may be associated with a second cyclic shift distance between second preamble sequences in the second set of preamble sequences, where the second cyclic shift distance is greater than or equal to the first cyclic shift distance. In some aspects, the second cyclic shift distance is greater than the first cyclic shift distance by a value based on a largest cyclic shift value in the third set of cyclic shift values.

In some aspects, the second RO may be indicated for transmitting additional (e.g., special) first messages associated with first messages transmitted via a plurality of ROs, where the first set of preamble sequences is associated with each of the plurality of ROs. There may be, in some aspects, a many-to-one mapping from first preamble sequences in the first set of preamble sequences associated with the plurality of ROS to second preamble sequences in the second set of preamble sequences, where each RO in the plurality of ROs may be associated with a corresponding subset of cyclic shift values in the third set of cyclic shift values that indicate the support for the capability of the UE. In some aspects, the cyclic shift values in each subset of cyclic shift values are disjoint from the cyclic shift values in other subsets of the cyclic shift values (as illustrated in FIG. 8), and different first preamble sequences (e.g., preamble sequences associated with the first Msg1 810 and the second Msg1 820) mapped to a same preamble sequence in the second set of preamble sequences (e.g., mapped to preamble sequence 861) are associated with a corresponding different subset of cyclic shift values (e.g., ΔCS₁ 860 and ΔCS₂ 870) in the third set of cyclic shift values. The first set of preamble sequences, in some aspects, may be associated with a first cyclic shift distance between the first preamble sequences in the first set of preamble sequences and the second set of preamble sequences may be associated with a second cyclic shift distance between the second preamble sequences in the second set of preamble sequences, where the second cyclic shift distance may be greater than the first cyclic shift distance by a value based on a largest cyclic shift value in the third set of cyclic shift values. In some aspects, the second preamble sequence is adjusted based on the first cyclic shift value before being used in the additional Msg 1 (e.g., if the first preamble sequence maps to the second preamble sequence with a sequence root “q” and a cyclic shift “n” and the first cyclic shift, or CS dithering value, is 2, then the preamble sequence used for the additional Msg 1 may have the sequence root “q” and a cyclic shift of “n+2”). For example, 1004 may be performed by application processor(s) 1306, cellular baseband processor(s) 1324, transceiver(s) 1322, antenna(s) 1380, and/or CS adjustment component 198 of FIG. 13. For example, referring to FIGS. 5A, 5B, and 6-9, the UE 402, the UE 904, or the UE 906 may transmit (e.g., via one the special RO(s) in either FIG. 5A or FIG. 5B), a first additional first random access message 661, a second additional first random access message 671, a first additional first random access message 761, a second additional first random access message 771, an additional Msg1 associated with one of a preamble sequence 861-864 or a preamble sequence 871-874, an additional first random access message 922, or an additional first random access message 924.

At 1006, the UE may receive a second random access message (Msg 2) based on the Msg 1 and the additional Msg 1. In some aspects, the Msg 2 may include an indication, to the UE, of an allocation of resources for transmitting a third random access message (a Msg 3). For example, 1004 may be performed by application processor(s) 1306, cellular baseband processor(s) 1324, transceiver(s) 1322, antenna(s) 1380, and/or CS adjustment component 198 of FIG. 13. For example, referring to FIG. 9, the UE 904 or the UE 906 may receive from the base station 902 one of the second random access message 928 or the second random access message 930.

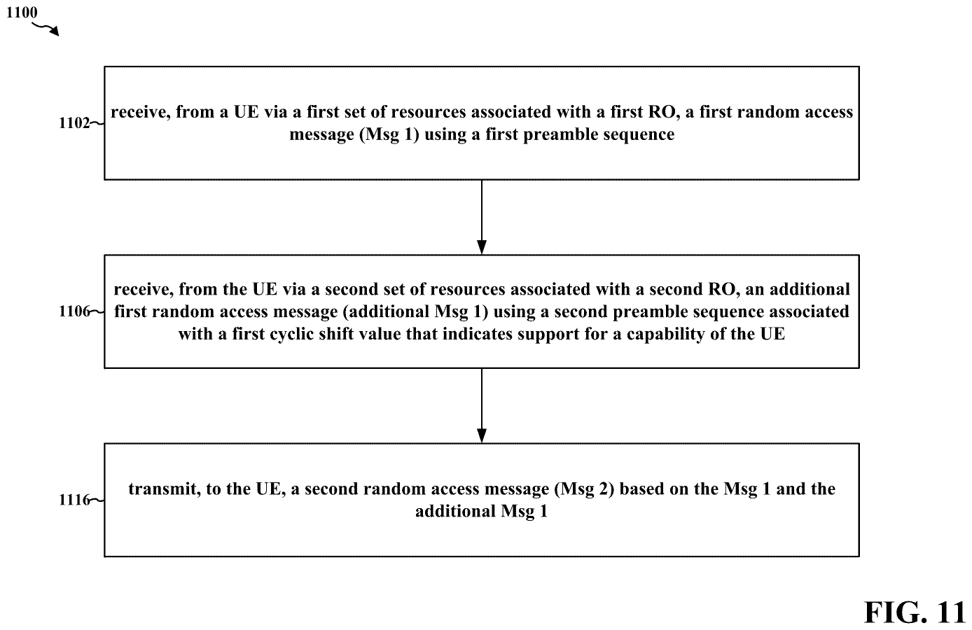

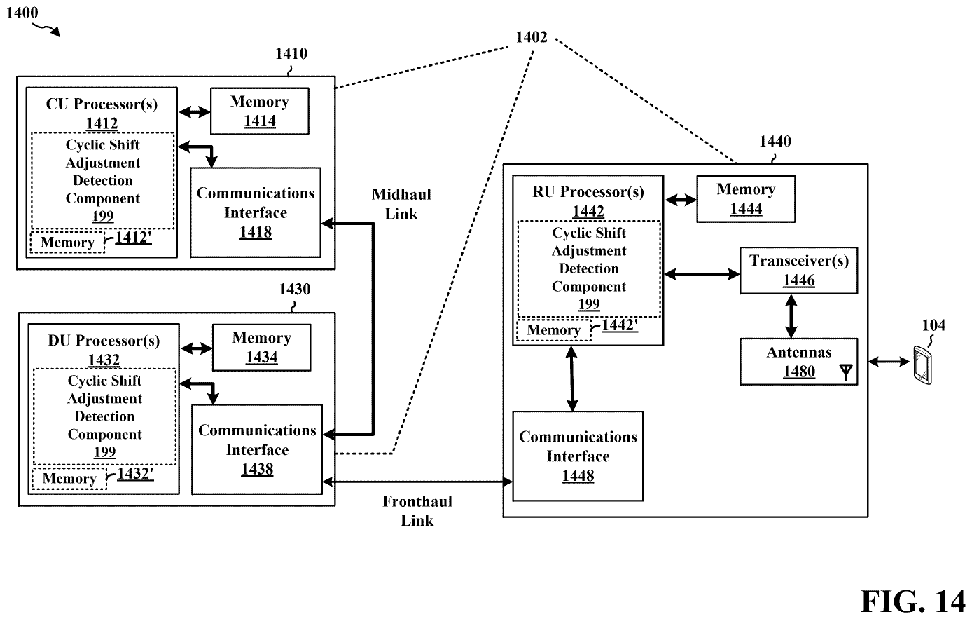

FIG. 11 is a flowchart 1100 of a method of wireless communication. The method may be performed by a network node such as a base station (e.g., the base station 102, 404, 902; the network entity 1302, 1402). At 1102, the network node may receive, from a (first) UE via a first set of resources associated with a first RO, a first random access message (Msg 1) using a first preamble sequence. For example, 1102 may be performed by CU processor(s) 1412, DU processor(s) 1432, RU processor(s) 1442, transceiver(s) 1446, antenna(s) 1480, and/or CS adjustment detection component 199 of FIG. 14. In some aspects, the first preamble sequence may be selected from a first set of preamble sequences associated with a first set of root indexes and a first set of cyclic shift values. For example, referring to FIGS. 4, 5A, 5B, and 6-9, the base station 902 may receive (e.g., via one of the ROs in the first set of ROs in either FIG. 5A or FIG. 5B) a first random access message 403, a first Msg1 610, a first Msg1 710, a first Msg1 810, or a first random access message 916. In some aspects, the Msg 1 is a first Msg 1.

In some aspects, the network node may receive, from a second UE via a third set of resources associated with a third RO, a second Msg 1 using a third preamble sequence. In some aspects, either (1) the third set of resources associated with the third RO may be the same as the first set of resources associated with the first RO or (2) the third preamble sequence may be the same as the first preamble sequence. However, if both the third set of resources associated with the third RO is the same as the first set of resources associated with the first RO and the third preamble sequence is the same as the first preamble sequence, there may be a conflict before that precludes the calculation of a TA value used in subsequent operations of the method of wireless communication. In some aspects, the third preamble sequence may be selected from the first set of preamble sequences associated with the first set of root indexes and the first set of cyclic shift values. For example, referring to FIGS. 4, 5A, 5B, and 6-9, the base station 902 may receive (e.g., via one of the ROs in the first set of ROs in either FIG. 5A or FIG. 5B) a first random access message 403, a second Msg1 620, a second Msg1 720, a second Msg1 820, or a first random access message 918.

At 1106, the network node may receive, from the (first) UE via a second set of resources associated with a second RO, an additional first random access message (additional Msg 1) using a second preamble sequence associated with a first cyclic shift value that indicates support for a capability of the UE. In some aspects, the additional Msg 1 is based on the Msg 1. The second RO, in some aspects, may be indicated for additional Msg 1 transmissions associated with prior Msg 1 transmissions in a single RO that corresponds to the first RO. In some aspects, a first set of preamble sequences, which are based on a first set of root indexes and a first set of cyclic shift values, are associated with both the first RO and the second RO. The second RO, in some aspects, may be indicated for additional Msg 1 transmissions associated with prior Msg 1 transmissions in any of a plurality of ROs, where the plurality of ROs includes the first RO. In some aspects, the first preamble sequence may be selected by the UE from a first set of preamble sequences including a first number of preamble sequences based on a first set of root indexes and a first set of cyclic shift values. In some aspects, the first set of preamble sequences is associated with each of the plurality of ROs, the plurality of ROs includes a second number of ROs, and the second preamble sequence is associated with one of: (1) a second set of preamble sequences associated with the second RO or (2) a third set of preamble sequences associated with the second RO. The second set of preamble sequences, in some aspects, may include a third number of preamble sequences based on a second set of root indexes and a second set of cyclic shift values, where the third number of preamble sequences is greater than or equal to the first number of preamble sequences multiplied by the second number of ROs, and where there is a one-to-one mapping from first preamble sequences in the first set of preamble sequences associated with each RO to second preamble sequences in the second set of preamble sequences. In some aspects, the third set of preamble sequences may include a fourth number of preamble sequences based on a third set of root indexes and a third set of cyclic shift values, where the fourth number of preamble sequences is smaller than the first number of preamble sequences multiplied by the second number of ROs, and where there is a many-to-one mapping from the first preamble sequences in the first set of preamble sequences associated with the plurality of ROs to third preamble sequences in the third set of preamble sequences. In some aspects, the first preamble sequence may be mapped to a corresponding preamble sequence in a second set of preamble sequences for the second RO associated with a second set of root indexes and a second set of cyclic shift values, where the corresponding preamble sequence is associated with a particular root index in the second set of root indexes and a particular cyclic shift value in the second set of cyclic shift values, and the second preamble sequence may be based on the particular root index and an applied cyclic shift value including a sum of the particular cyclic shift value and the first cyclic shift value, and where the first cyclic shift value is selected from a third set of cyclic shift values (e.g., a set of cyclic shift values, or CS dithering values, used to indicate the support for the capability of the UE). The first set of preamble sequences, in some aspects, may be associated with a first cyclic shift distance between first preamble sequences in the first set of preamble sequences and the second set of preamble sequences may be associated with a second cyclic shift distance between second preamble sequences in the second set of preamble sequences, where the second cyclic shift distance is greater than or equal to the first cyclic shift distance. In some aspects, the second cyclic shift distance is greater than the first cyclic shift distance by a value based on a largest cyclic shift value in the third set of cyclic shift values.

In some aspects, the second RO may be indicated for transmitting additional (e.g., special) first messages associated with first messages transmitted via a plurality of ROs, where the first set of preamble sequences is associated with each of the plurality of ROs. There may be, in some aspects, a many-to-one mapping from first preamble sequences in the first set of preamble sequences associated with the plurality of ROs to second preamble sequences in the second set of preamble sequences, where each RO in the plurality of ROs may be associated with a corresponding subset of cyclic shift values in the third set of cyclic shift values that indicate the support for the capability of the UE. In some aspects, the cyclic shift values in each subset of cyclic shift values are disjoint from the cyclic shift values in other subsets of the cyclic shift values (as illustrated in FIG. 8), and different first preamble sequences (e.g., preamble sequences associated with the first Msg1 810 and the second Msg1 820) mapped to a same preamble sequence in the second set of preamble sequences (e.g., mapped to preamble sequence 861) are associated with a corresponding different subset of cyclic shift values (e.g., ΔCS₁ 860 and ΔCS₂ 870) in the third set of cyclic shift values. The first set of preamble sequences, in some aspects, may be associated with a first cyclic shift distance between the first preamble sequences in the first set of preamble sequences and the second set of preamble sequences may be associated with a second cyclic shift distance between the second preamble sequences in the second set of preamble sequences, where the second cyclic shift distance may be greater than the first cyclic shift distance by a value based on a largest cyclic shift value in the third set of cyclic shift values. In some aspects, the second preamble sequence is adjusted based on the first cyclic shift value before being used in the additional Msg 1 (e.g., if the first preamble sequence maps to the second preamble sequence with a sequence root “q” and a cyclic shift “n” and the first cyclic shift, or CS dithering value, is 2, then the preamble sequence used for the additional Msg 1 may have the sequence root “q” and a cyclic shift of “n+2”). For example, 1106 may be performed by CU processor(s) 1412, DU processor(s) 1432, RU processor(s) 1442, transceiver(s) 1446, antenna(s) 1480, and/or CS adjustment detection component 199 of FIG. 14. In some aspects, the second preamble sequence may be selected from the first set of preamble sequences associated with the first set of root indexes and the first set of cyclic shift values. The second preamble sequence may be selected from the second set of preamble sequences associated with the second set of root indexes and the second set of cyclic shift values. For example, referring to FIGS. 4, 5A, 5B, and 6-9, the base station 902 may receive (e.g., via one of the ROs in the first set of ROs in either FIG. 5A or FIG. 5B) a first additional first random access message 661, a first additional first random access message 761, an additional Msg1 associated with one of a preamble sequence 861-864, or an additional first random access message 922.

In some aspects, the UE may receive, from the second UE via the second set of resources associated with the second RO, a second additional Msg 1 using a fourth preamble sequence associated with a second cyclic shift value that indicates the support for a second capability of the second UE, where the second additional Msg 1 is based on the second Msg 1. In some aspects, the fourth preamble sequence may be the same as the second preamble sequence. Other aspects of the fourth preamble sequence may be similar to the aspects of the second preamble sequence described above. In some aspects, the fourth preamble sequence may be selected from the first set of preamble sequences associated with the first set of root indexes and the first set of cyclic shift values. The fourth preamble sequence may be selected from the second set of preamble sequences associated with the second set of root indexes and the second set of cyclic shift values. For example, referring to FIGS. 4, 5A, 5B, and 6-9, the base station 902 may receive (e.g., via one of the ROs in the first set of ROs in either FIG. 5A or FIG. 5B) a second additional first random access message 671, a second additional first random access message 771, an additional Msg1 associated with one of a preamble sequence 871-874, or an additional first random access message 924.

In some aspects, the network node may associate the first Msg 1 with the first additional Msg 1 and may associate the second Msg 1 with the second additional Msg 1. Associating the first Msg 1 with the first additional Msg 1 and associating the second Msg 1 with the second additional Msg 1, in some aspects, may be based on one or more of: (1) a first timing advance value associated with the first Msg 1 and the first additional Msg 1 received from the first UE and a second timing advance value associated with the second Msg 1 and the second additional Msg 1 received from the second UE, (2) a first received power associated with the first Msg 1 and the first additional Msg 1 from the first UE and a second received power associated with the second Msg 1 and the second additional Msg 1 received from the second UE, or (3) or a first set of cyclic shift values associated with the first Msg 1 and the first additional Msg 1 from the first UE (e.g., based on being associated with the first RO) and a second set of cyclic shift values associated with the second Msg 1 and the second additional Msg 1 from the second UE (e.g., based on being associated with the third RO). For example, referring to FIGS. 6, 7, and 9, the base station 902 may determine a UE capability associated with each of the UE 904 and the UE 906 and allocate (or determine an allocation of) resources for a third random access message of the random access procedure. For example, in some aspects, the base station, at 926, may associate the first random access message 916 with the additional first random access message 922 and associating the first random access message 918 with the additional first random access message 924 (or associate a first Msg1 610 with a first additional first random access message 661, a second Msg1 620 with a second additional first random access message 671, a first Msg1 710 with a first additional first random access message 761, a second Msg1 720 with a second additional first random access message 771, a first Msg1 810 with an additional Msg1 associated with one of a preamble sequence 861-864, a second Msg1 820 with an additional Msg1 associated with one of a preamble sequence 871-874).

The network node, in some aspects may allocate, based on the second preamble sequence, first resources for a third random access message (first Msg 3). In some aspects, the first cyclic shift value indicates the support for a first capability of the UE, and allocating the first resources may include allocating, based on the first capability of the UE, the first resources for the third random access message (Msg 3). For example, referring to FIG. 9, the base station 902, at 926, may allocate, based on the additional first random access message 922 (e.g., based on the second preamble sequence adjusted based on the CS dithering value determined at 912), first resources for a third random access message (a first Msg3). In some aspects, the network node may allocate, based on the fourth preamble sequence, second resources for a second Msg 3. In some aspects, preamble sequences used by UEs to transmit additional first random access messages (additional Msg 1's) first messages are selected from a set of preamble sequences used to indicate a corresponding set of UE capabilities, and when the network node fails to separately detect at least one of the first additional Msg 1 and the second additional Msg 1, the first resources and the second resources are allocated based on one of a first lowest UE capability in the corresponding set of UE capabilities or a second lowest UE capability consistent with the first Msg 1, the first additional Msg 1, the second Msg 1, and the second additional Msg 1 received by the network node. For example, referring to FIG. 9, the base station 902, at 926, may allocate, based on the additional first random access message 924 (e.g., based on the fourth preamble sequence adjusted based on the CS dithering value determined at 914), second resources for a third random access message (the second Msg3 934).

At 1116, the network node may transmit, to the (first) UE, a second random access message (Msg 2) based on the first Msg 1 and the first additional Msg 1. For example, 1116 may be performed by CU processor(s) 1412, DU processor(s) 1432, RU processor(s) 1442, transceiver(s) 1446, antenna(s) 1480, and/or CS adjustment detection component 199 of FIG. 14. In some aspects, the first Msg 2 may indicate, to the first UE, the allocation of the first resources for the first Msg 3. For example, referring to FIG. 9, the base station 902 may transmit, and the UE 904 may receive, a second random access message 928 (e.g., a first Msg2) indicating the allocated resources (e.g., the resources allocated at 926).

In some aspects, the network node may transmit, to the second UE, a second Msg 2 based on the second Msg 1 and the second additional Msg 1. In some aspects, the second Msg 2 may indicate, to the second UE, the allocation of the second resources for the second Msg 3. For example, referring to FIG. 9, the base station 902 may transmit, and the UE 906 may receive, a second random access message 930 (e.g., a second Msg2) indicating the allocated resources (e.g., the resources allocated at 926).

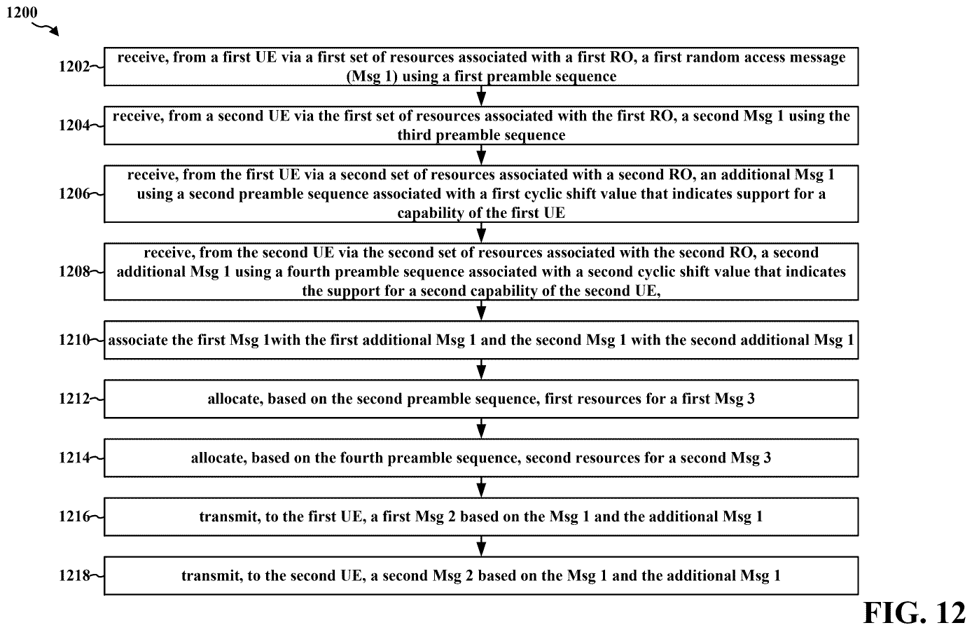

FIG. 12 is a flowchart 1200 of a method of wireless communication. The method may be performed by a network node such as a base station (e.g., the base station 102, 404, 902; the network entity 1302, 1402). At 1202, the network node may receive, from a (first) UE via a first set of resources associated with a first RO, a first random access message (Msg 1) using a first preamble sequence. For example, 1202 may be performed by CU processor(s) 1412, DU processor(s) 1432, RU processor(s) 1442, transceiver(s) 1446, antenna(s) 1480, and/or CS adjustment detection component 199 of FIG. 14. In some aspects, the first preamble sequence may be selected from a first set of preamble sequences associated with a first set of root indexes and a first set of cyclic shift values. For example, referring to FIGS. 4, 5A, 5B, and 6-9, the base station 902 may receive (e.g., via one of the ROs in the first set of ROs in either FIG. 5A or FIG. 5B) a first random access message 403, a first Msg1 610, a first Msg1 710, a first Msg1 810, or a first random access message 916. In some aspects, the Msg 1 is a first Msg 1.

At 1204, the network node may receive, from a second UE via a third set of resources associated with a third RO, a second Msg 1 using a third preamble sequence. In some aspects, either (1) the third set of resources associated with the third RO may be the same as the first set of resources associated with the first RO or (2) the third preamble sequence may be the same as the first preamble sequence. However, if both the third set of resources associated with the third RO is the same as the first set of resources associated with the first RO and the third preamble sequence is the same as the first preamble sequence, there may be a conflict before that precludes the calculation of a TA value used in subsequent operations of the method of wireless communication. For example, 1204 may be performed by CU processor(s) 1412, DU processor(s) 1432, RU processor(s) 1442, transceiver(s) 1446, antenna(s) 1480, and/or CS adjustment detection component 199 of FIG. 14. In some aspects, the third preamble sequence may be selected from the first set of preamble sequences associated with the first set of root indexes and the first set of cyclic shift values. For example, referring to FIGS. 4, 5A, 5B, and 6-9, the base station 902 may receive (e.g., via one of the ROs in the first set of ROs in either FIG. 5A or FIG. 5B) a first random access message 403, a second Msg1 620, a second Msg1 720, a second Msg1 820, or a first random access message 918.

At 1206, the network node may receive, from the (first) UE via a second set of resources associated with a second RO, an additional first random access message (additional Msg 1) using a second preamble sequence associated with a first cyclic shift value that indicates support for a capability of the UE. In some aspects, the additional Msg 1 is based on the Msg 1. The second RO, in some aspects, may be indicated for additional Msg 1 transmissions associated with prior Msg 1 transmissions in a single RO that corresponds to the first RO. In some aspects, a first set of preamble sequences, which are based on a first set of root indexes and a first set of cyclic shift values, are associated with both the first RO and the second RO. The second RO, in some aspects, may be indicated for additional Msg 1 transmissions associated with prior Msg 1 transmissions in any of a plurality of ROs, where the plurality of ROs includes the first RO. In some aspects, the first preamble sequence may be selected by the UE from a first set of preamble sequences including a first number of preamble sequences based on a first set of root indexes and a first set of cyclic shift values. In some aspects, the first set of preamble sequences is associated with each of the plurality of ROs, the plurality of ROs includes a second number of ROs, and the second preamble sequence is associated with one of: (1) a second set of preamble sequences associated with the second RO or (2) a third set of preamble sequences associated with the second RO. The second set of preamble sequences, in some aspects, may include a third number of preamble sequences based on a second set of root indexes and a second set of cyclic shift values, where the third number of preamble sequences is greater than or equal to the first number of preamble sequences multiplied by the second number of ROs, and where there is a one-to-one mapping from first preamble sequences in the first set of preamble sequences associated with each RO to second preamble sequences in the second set of preamble sequences. In some aspects, the third set of preamble sequences may include a fourth number of preamble sequences based on a third set of root indexes and a third set of cyclic shift values, where the fourth number of preamble sequences is smaller than the first number of preamble sequences multiplied by the second number of ROs, and where there is a many-to-one mapping from the first preamble sequences in the first set of preamble sequences associated with the plurality of ROs to third preamble sequences in the third set of preamble sequences. In some aspects, the first preamble sequence may be mapped to a corresponding preamble sequence in a second set of preamble sequences for the second RO associated with a second set of root indexes and a second set of cyclic shift values, where the corresponding preamble sequence is associated with a particular root index in the second set of root indexes and a particular cyclic shift value in the second set of cyclic shift values, and the second preamble sequence may be based on the particular root index and an applied cyclic shift value including a sum of the particular cyclic shift value and the first cyclic shift value, and where the first cyclic shift value is selected from a third set of cyclic shift values (e.g., a set of cyclic shift values, or CS dithering values, used to indicate the support for the capability of the UE). The first set of preamble sequences, in some aspects, may be associated with a first cyclic shift distance between first preamble sequences in the first set of preamble sequences and the second set of preamble sequences may be associated with a second cyclic shift distance between second preamble sequences in the second set of preamble sequences, where the second cyclic shift distance is greater than or equal to the first cyclic shift distance. In some aspects, the second cyclic shift distance is greater than the first cyclic shift distance by a value based on a largest cyclic shift value in the third set of cyclic shift values.

In some aspects, the second RO may be indicated for transmitting additional first messages associated with first messages transmitted via a plurality of ROs, where the first set of preamble sequences is associated with each of the plurality of ROs. There may be, in some aspects, a many-to-one mapping from first preamble sequences in the first set of preamble sequences associated with the plurality of ROs to second preamble sequences in the second set of preamble sequences, where each RO in the plurality of ROs may be associated with a corresponding subset of cyclic shift values in the third set of cyclic shift values that indicate the support for the capability of the UE. In some aspects, the cyclic shift values in each subset of cyclic shift values are disjoint from the cyclic shift values in other subsets of the cyclic shift values (as illustrated in FIG. 8), and different first preamble sequences (e.g., preamble sequences associated with the first Msg1 810 and the second Msg1 820) mapped to a same preamble sequence in the second set of preamble sequences (e.g., mapped to preamble sequence 861) are associated with a corresponding different subset of cyclic shift values (e.g., ΔCS₁ 860 and ΔCS₂ 870) in the third set of cyclic shift values. The first set of preamble sequences, in some aspects, may be associated with a first cyclic shift distance between the first preamble sequences in the first set of preamble sequences and the second set of preamble sequences may be associated with a second cyclic shift distance between the second preamble sequences in the second set of preamble sequences, where the second cyclic shift distance may be greater than the first cyclic shift distance by a value based on a largest cyclic shift value in the third set of cyclic shift values. In some aspects, the second preamble sequence is adjusted based on the first cyclic shift value before being used in the additional Msg 1 (e.g., if the first preamble sequence maps to the second preamble sequence with a sequence root “q” and a cyclic shift “n” and the first cyclic shift, or CS dithering value, is 2, then the preamble sequence used for the additional Msg 1 may have the sequence root “q” and a cyclic shift of “n+2”). For example, 1206 may be performed by CU processor(s) 1412, DU processor(s) 1432, RU processor(s) 1442, transceiver(s) 1446, antenna(s) 1480, and/or CS adjustment detection component 199 of FIG. 14. In some aspects, the second preamble sequence may be selected from the first set of preamble sequences associated with the first set of root indexes and the first set of cyclic shift values. The second preamble sequence may be selected from the second set of preamble sequences associated with the second set of root indexes and the second set of cyclic shift values. For example, referring to FIGS. 4, 5A, 5B, and 6-9, the base station 902 may receive (e.g., via one of the ROs in the first set of ROs in either FIG. 5A or FIG. 5B) a first additional first random access message 661, a first additional first random access message 761, an additional Msg1 associated with one of a preamble sequence 861-864, or an additional first random access message 922.

At 1208, the UE may receive, from the second UE via the second set of resources associated with the second RO, a second additional Msg 1 using a fourth preamble sequence associated with a second cyclic shift value that indicates the support for a second capability of the second UE, where the second additional Msg 1 is based on the second Msg 1. In some aspects, the fourth preamble sequence may be the same as the second preamble sequence. Other aspects of the fourth preamble sequence may be similar to the aspects of the second preamble sequence described above. For example, 1208 may be performed by CU processor(s) 1412, DU processor(s) 1432, RU processor(s) 1442, transceiver(s) 1446, antenna(s) 1480, and/or CS adjustment detection component 199 of FIG. 14. In some aspects, the fourth preamble sequence may be selected from the first set of preamble sequences associated with the first set of root indexes and the first set of cyclic shift values. The fourth preamble sequence may be selected from the second set of preamble sequences associated with the second set of root indexes and the second set of cyclic shift values. For example, referring to FIGS. 4, 5A, 5B, and 6-9, the base station 902 may receive (e.g., via one of the ROs in the first set of ROs in either FIG. 5A or FIG. 5B) a second additional first random access message 671, a second additional first random access message 771, an additional Msg1 associated with one of a preamble sequence 871-874, or an additional first random access message 924.

At 1210, the network node may associate the first Msg 1 with the first additional Msg 1 and may associate the second Msg 1 with the second additional Msg 1. Associating the first Msg 1 with the first additional Msg 1 and associating the second Msg 1 with the second additional Msg 1, at 1210, in some aspects, may be based on one or more of: (1) a first timing advance value associated with the first Msg 1 and the first additional Msg 1 received from the first UE and a second timing advance value associated with the second Msg 1 and the second additional Msg 1 received from the second UE, (2) a first received power associated with the first Msg 1 and the first additional Msg 1 from the first UE and a second received power associated with the second Msg 1 and the second additional Msg 1 received from the second UE, or (3) or a first set of cyclic shift values associated with the first Msg 1 and the first additional Msg 1 from the first UE (e.g., based on being associated with the first RO) and a second set of cyclic shift values associated with the second Msg 1 and the second additional Msg 1 from the second UE (e.g., based on being associated with the third RO). For example, 1210 may be performed by CU processor(s) 1412, DU processor(s) 1432, RU processor(s) 1442, transceiver(s) 1446, antenna(s) 1480, and/or CS adjustment detection component 199 of FIG. 14. For example, referring to FIGS. 6, 7, and 9, the base station 902 may determine a UE capability associated with each of the UE 904 and the UE 906 and allocate (or determine an allocation of) resources for a third random access message of the random access procedure. For example, in some aspects, the base station, at 926, may associate the first random access message 916 with the additional first random access message 922 and associating the first random access message 918 with the additional first random access message 924 (or associate a first Msg1 610 with a first additional first random access message 661, a second Msg1 620 with a second additional first random access message 671, a first Msg1 710 with a first additional first random access message 761, a second Msg1 720 with a second additional first random access message 771, a first Msg1 810 with an additional Msg1 associated with one of a preamble sequence 861-864, a second Msg1 820 with an additional Msg1 associated with one of a preamble sequence 871-874).

At 1212, the network node may allocate, based on the second preamble sequence, first resources for a third random access message (first Msg 3). For example, 1212 may be performed by CU processor(s) 1412, DU processor(s) 1432, RU processor(s) 1442, transceiver(s) 1446, antenna(s) 1480, and/or CS adjustment detection component 199 of FIG. 14. In some aspects, the first cyclic shift value indicates the support for a first capability of the UE, and allocating the first resources may include allocating, based on the first capability of the UE, the first resources for the third random access message (Msg 3). For example, referring to FIG. 9, the base station 902, at 926, may allocate, based on the additional first random access message 922 (e.g., based on the second preamble sequence adjusted based on the CS dithering value determined at 912), first resources for a third random access message (a first Msg3).

At 1214, the network node may allocate, based on the fourth preamble sequence, second resources for a second Msg 3. For example, 1214 may be performed by CU processor(s) 1412, DU processor(s) 1432, RU processor(s) 1442, transceiver(s) 1446, antenna(s) 1480, and/or CS adjustment detection component 199 of FIG. 14. In some aspects, preamble sequences used by UEs to transmit additional first random access messages (additional Msg 1's) first messages are selected from a set of preamble sequences used to indicate a corresponding set of UE capabilities, and when the network node fails to separately detect at least one of the first additional Msg 1 and the second additional Msg 1, the first resources and the second resources are allocated based on one of a first lowest UE capability in the corresponding set of UE capabilities or a second lowest UE capability consistent with the first Msg 1, the first additional Msg 1, the second Msg 1, and the second additional Msg 1 received by the network node. For example, referring to FIG. 9, the base station 902, at 926, may allocate, based on the additional first random access message 924 (e.g., based on the fourth preamble sequence adjusted based on the CS dithering value determined at 914), second resources for a third random access message (the second Msg3 934).

At 1216, the network node may transmit, to the (first) UE, a second random access message (Msg 2) based on the first Msg 1 and the first additional Msg 1. For example, 1216 may be performed by CU processor(s) 1412, DU processor(s) 1432, RU processor(s) 1442, transceiver(s) 1446, antenna(s) 1480, and/or CS adjustment detection component 199 of FIG. 14. In some aspects, the first Msg 2 may indicate, to the first UE, the allocation of the first resources for the first Msg 3. For example, referring to FIG. 9, the base station 902 may transmit, and the UE 904 may receive, a second random access message 928 (e.g., a first Msg2) indicating the allocated resources (e.g., the resources allocated at 926).

At 1218, the network node may transmit, to the second UE, a second Msg 2 based on the second Msg 1 and the second additional Msg 1. For example, 1216 may be performed by CU processor(s) 1412, DU processor(s) 1432, RU processor(s) 1442, transceiver(s) 1446, antenna(s) 1480, and/or CS adjustment detection component 199 of FIG. 14. In some aspects, the second Msg 2 may indicate, to the second UE, the allocation of the second resources for the second Msg 3. For example, referring to FIG. 9, the base station 902 may transmit, and the UE 906 may receive, a second random access message 930 (e.g., a second Msg2) indicating the allocated resources (e.g., the resources allocated at 926).

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize one or more antennas 1380 for communication. The cellular baseband processor(s) 1324 communicates through the transceiver(s) 1322 via the one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The cellular baseband processor(s) 1324 and the application processor(s) 1306 are configured to perform the various functions described supra based at least in part of the information stored in the memory. That is, the cellular baseband processor(s) 1324 and the application processor(s) 1306 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the CS adjustment component 198 may be configured to transmit, via a first set of resources associated with a first RO, a first random access message (Msg 1) using a first preamble sequence, transmit, via a second set of resources associated with a second RO, an additional first random access message (additional Msg 1) using a second preamble sequence associated with a first cyclic shift value that indicates support for a capability of the UE, where the additional Msg 1 is based on the Msg 1, and receive a second random access message (Msg 2) based on the Msg 1 and the additional Msg 1. The CS adjustment component 198 may be within the cellular baseband processor(s) 1324, the application processor(s) 1306, or both the cellular baseband processor(s) 1324 and the application processor(s) 1306. The CS adjustment component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for transmitting, via a first set of resources associated with a first random access channel (RACH) occasion (RO), a first random access message (Msg 1) using a first preamble sequence. The apparatus 1304, and in particular the cellular baseband processor(s) 1324 and/or the application processor(s) 1306, may include means for transmitting, via a second set of resources associated with a second RO, an additional first random access message (additional Msg 1) using a second preamble sequence associated with a first cyclic shift value that indicates support for a capability of the UE. The apparatus 1304, and in particular the cellular baseband processor(s) 1324 and/or the application processor(s) 1306, may include means for receiving a second random access message (Msg 2) based on the Msg 1 and the additional Msg 1. The apparatus 1304 may further include means for performing any of the aspects described in connection with the flowchart in FIG. 10, and/or performed by the UE 904 or the UE 906 in the communication flow of FIG. 9. The means may be the CS adjustment component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the CS adjustment detection component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor 1412. The CU processor(s) 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include at least one DU processor 1432. The DU processor(s) 1432 may include on-chip memory 1432′. In some aspects, the DU 1430 may further include additional memory modules 1434 and a communications interface 1438. The DU 1430 communicates with the RU 1440 through a fronthaul link. The RU 1440 may include at least one RU processor 1442. The RU processor(s) 1442 may include on-chip memory 1442′. In some aspects, the RU 1440 may further include additional memory modules 1444, one or more transceivers 1446, one or more antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the CS adjustment detection component 199 may be configured to receive, from a UE via a first set of resources associated with a first RO, a first random access message (Msg 1) using a first preamble sequence, receive, from the UE via a second set of resources associated with a second RO, an additional first random access message (additional Msg 1) using a second preamble sequence associated with a first cyclic shift value that indicates support for a capability of the UE, where the additional Msg 1 is based on the Msg 1, and transmit, to the UE, a second random access message (Msg 2) based on the Msg 1 and the additional Msg 1. The CS adjustment detection component 199 may be within one or more processors of one or more of the CU 1410, DU 1430, and the RU 1440. The CS adjustment detection component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 may include means for receiving, from a user equipment (UE) via a first set of resources associated with a first random access channel (RACH) occasion (RO), a first random access message (Msg 1) using a first preamble sequence. The network entity 1402, in some aspects, may include means for receiving, from the UE via a second set of resources associated with a second RO, an additional first random access message (additional Msg 1) using a second preamble sequence associated with a first cyclic shift value that indicates support for a capability of the UE. The network entity 1402, in some aspects, may include means for transmitting, to the UE, a second random access message (Msg 2) based on the Msg 1 and the additional Msg 1. The network entity 1402, in some aspects, may include means for allocating, based on the first capability of the UE, resources for a third random access message (Msg 3). The network entity 1402, in some aspects, may include means for receiving, from a second UE via a third first set of resources associated with a third RO, a second Msg 1 using a third preamble sequence. The network entity 1402, in some aspects, may include means for receiving, from the second UE via the second set of resources associated with the second RO, a second additional Msg 1 using a fourth preamble sequence associated with a second cyclic shift value that indicates the support for a second capability of the second UE. The network entity 1402, in some aspects, may include means for transmitting, to the second UE, a second Msg 2 based on the second Msg 1 and the second additional Msg 1. The network entity 1402, in some aspects, may include means for associating the first Msg 1 with the first additional Msg 1 and associating the second Msg 1 with the second additional Msg 1 based on one or more of. a first timing advance value associated with the first Msg 1 and the first additional Msg 1 received from the first UE and a second timing advance value associated with the second Msg 1 and the second additional Msg 1 received from the second UE, a first set of cyclic shift values associated with the first Msg 1 and the first additional Msg 1 from the first UE and a second set of cyclic shift values associated with the second Msg 1 and the second additional Msg 1 from the second UE, or a first received power associated with the first Msg 1 and the first additional Msg 1 from the first UE and a second received power associated with the second Msg 1 and the second additional Msg 1 received from the second UE. The network entity 1402, in some aspects, may include means for allocating, based on the second preamble sequence, first resources for a third random access message (first Msg 3). The network entity 1402, in some aspects, may include means for allocating, based on the fourth preamble sequence, second resources for a second Msg 3. The network entity 1402 may further include means for performing any of the aspects described in connection with the flowchart in FIGS. 11 and 12, and/or performed by the base station in the communication flow of FIG. 9. The means may be the CS adjustment detection component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

Particular aspects of the subject matter described in this disclosure can be implemented to realize one or more of the following potential advantages. In some examples, by utilizing CS dithering (e.g., a CS shift or CS adjustment), the described techniques can be used to indicate, in a first message of a RACH procedure, information used to allocate resources for a third message of the RACH procedure, e.g., to allocate resources that are compatible with the capability of a device and/or UE associated with the RACH procedure, while reducing the likelihood of collisions associated with the use of preamble partitioning to indicate the information.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: transmitting, via a first set of resources associated with a first random access channel (RACH) occasion (RO), a first random access message (Msg 1) using a first preamble sequence; transmitting, via a second set of resources associated with a second RO, an additional first random access message (additional Msg 1) using a second preamble sequence associated with a first cyclic shift value that indicates support for a capability of the UE, wherein the additional Msg 1 is based on the Msg 1; and receiving a second random access message (Msg 2) based on the Msg 1 and the additional Msg 1.

Aspect 2 is the method of aspect 1, wherein the second RO is indicated for additional Msg 1 transmissions associated w with prior Msg 1 transmissions in the first RO.

Aspect 3 is the method of aspect 2, wherein a first set of preamble sequences, which are based on a first set of root indexes and a first set of cyclic shift values, are associated with both the first RO and the second RO.

Aspect 4 is the method of aspect 1, wherein the second RO is indicated for additional Msg 1 transmissions associated with prior Msg 1 transmissions in any of a plurality of ROs, wherein the plurality of ROs comprises the first RO.

Aspect 5 is the method of aspect 4, wherein the first preamble sequence is selected by the UE from a first set of preamble sequences comprising a first number of preamble sequences based on a first set of root indexes and a first set of cyclic shift values, wherein the first set of preamble sequences is associated with each of the plurality of ROs, wherein the plurality of ROs comprises a second number of ROs, and wherein the second preamble sequence is associated with one of: a second set of preamble sequences associated with the second RO, wherein the second set of preamble sequences comprises a third number of preamble sequences based on a second set of root indexes and a second set of cyclic shift values, wherein the third number of preamble sequences is greater than or equal to the first number of preamble sequences multiplied by the second number of ROs, and wherein there is a one-to-one mapping from first preamble sequences in the first set of preamble sequences associated with each RO to second preamble sequences in the second set of preamble sequences; or a third set of preamble sequences associated with the second RO, wherein the third set of preamble sequences comprises a fourth number of preamble sequences based on a third set of root indexes and a third set of cyclic shift values, wherein the fourth number of preamble sequences is smaller than the first number of preamble sequences multiplied by the second number of ROs, and wherein there is a many-to-one mapping from the first preamble sequences in the first set of preamble sequences associated with the plurality of ROs to third preamble sequences in the third set of preamble sequences.

Aspect 6 is the method of aspect 1, wherein the first preamble sequence is selected from a first set of preamble sequences associated with a first set of root indexes and a first set of cyclic shift values, wherein the first preamble sequence is mapped to a corresponding preamble sequence in a second set of preamble sequences for the second RO associated with a second set of root indexes and a second set of cyclic shift values, wherein the corresponding preamble sequence is associated with a particular root index in the second set of root indexes and a particular cyclic shift value in the second set of cyclic shift values, wherein the second preamble sequence is based on the particular root index and an applied cyclic shift value comprising a sum of the particular cyclic shift value and the first cyclic shift value, and wherein the first cyclic shift value is selected from a third set of cyclic shift values.

Aspect 7 is the method of aspect 6, wherein the first set of preamble sequences is associated with a first cyclic shift distance between first preamble sequences in the first set of preamble sequences and the second set of preamble sequences is associated with a second cyclic shift distance between second preamble sequences in the second set of preamble sequences, wherein the second cyclic shift distance is greater than or equal to the first cyclic shift distance.

Aspect 8 is the method of aspect 7, wherein the second cyclic shift distance is greater than the first cyclic shift distance by a value based on a largest cyclic shift value in the third set of cyclic shift values.

Aspect 9 is the method of any of aspects 6 to 8, wherein the second RO is indicated for transmitting additional Msg 1 transmissions associated with prior Msg 1 transmissions in any of a plurality of ROs, wherein the first set of preamble sequences is associated with each of the plurality of ROs, wherein there is a many-to-one mapping from first preamble sequences in the first set of preamble sequences associated with the plurality of ROs to second preamble sequences in the second set of preamble sequences, wherein each RO in the plurality of ROs is associated with a corresponding subset of cyclic shift values in the third set of cyclic shift values that indicate the support for the capability of the UE, wherein the cyclic shift values in each subset of cyclic shift values are disjoint from the cyclic shift values in other subsets of the cyclic shift values, and wherein different first preamble sequences mapped to a same preamble sequence in the second set of preamble sequences are associated with a corresponding different subset of cyclic shift values in the third set of cyclic shift values.

Aspect 10 is the method of aspect 9, wherein the first set of preamble sequences is associated with a first cyclic shift distance between the first preamble sequences in the first set of preamble sequences and the second set of preamble sequences is associated with a second cyclic shift distance between the second preamble sequences in the second set of preamble sequences, wherein the second cyclic shift distance is greater than the first cyclic shift distance by a value based on a largest cyclic shift value in the third set of cyclic shift values.

Aspect 11 is a method of wireless communication at a network node, comprising: receiving, from a user equipment (UE) via a first set of resources associated with a first random access channel (RACH) occasion (RO), a first random access message (Msg 1) using a first preamble sequence; receiving, from the UE via a second set of resources associated with a second RO, an additional first random access message (additional Msg 1) using a second preamble sequence associated with a first cyclic shift value that indicates support for a capability of the UE, wherein the additional Msg 1 is based on the Msg 1; and transmitting, to the UE, a second random access message (Msg 2) based on the Msg 1 and the additional Msg 1.

Aspect 12 is the method of aspect 11, wherein the second RO is indicated for additional Msg 1 transmissions associated with prior Msg 1 transmissions in the first RO.

Aspect 13 is the method of aspect 12, wherein a first set of preamble sequences, which are based on a first set of root indexes and a first set of cyclic shift values, are associated with both the first RO and the second RO.

Aspect 14 is the method of 11, wherein the second RO is indicated for additional Msg 1 transmissions associated with prior Msg 1 transmissions in any of a plurality of ROs, wherein the plurality of ROs comprises the first RO.

Aspect 15 is the method of aspect 14, wherein the first preamble sequence is selected by the UE from a first set of preamble sequences comprising a first number of preamble sequences based on a first set of root indexes and a first set of cyclic shift values, wherein the first set of preamble sequences is associated with each of the plurality of ROs, wherein the plurality of ROs comprises a second number of ROS, and wherein the second preamble sequence is associated with one of: a second set of preamble sequences associated with the second RO, wherein the second set of preamble sequences comprises a third number of preamble sequences based on a second set of root indexes and a second set of cyclic shift values, wherein the third number of preamble sequences is greater than or equal to the first number of preamble sequences multiplied by the second number of ROs, and wherein there is a one-to-one mapping from first preamble sequences in the first set of preamble sequences associated with each RO to second preamble sequences in the second set of preamble sequences; or a third set of preamble sequences associated with the second RO, wherein the third set of preamble sequences comprises a fourth number of preamble sequences based on a third set of root indexes and a third set of cyclic shift values, wherein the fourth number of preamble sequences is smaller than the first number of preamble sequences multiplied by the second number of ROs, and wherein there is a many-to-one mapping from the first preamble sequences in the first set of preamble sequences associated with the plurality of ROs to third preamble sequences in the third set of preamble sequences.

Aspect 16 is the method of aspect 11, wherein the first cyclic shift value indicates the support for a first capability of the UE, the method further comprising: allocating, based on the first capability of the UE, resources for a third random access message (Msg 3), and wherein transmitting the Msg 2 to the UE comprises transmitting an indication, to the UE, of an allocation of the resources for transmitting the Msg 3.

Aspect 17 is the method of any of aspects 11 and 16, wherein the first preamble sequence is selected from a first set of preamble sequences associated with a first set of root indexes and a first set of cyclic shift values, wherein the first preamble sequence is mapped to a corresponding preamble sequence in a second set of preamble sequences for the second RO associated with a second set of root indexes and a second set of cyclic shift values, wherein the corresponding preamble sequence is associated with a particular root index in the second set of root indexes and a particular cyclic shift value in the second set of cyclic shift values, wherein the second preamble sequence is based on the particular root index and an applied cyclic shift value comprising a sum of the particular cyclic shift value and the first cyclic shift value, and wherein the first cyclic shift value is selected from a third set of cyclic shift values.

Aspect 18 is the method of aspect 17, wherein the first set of preamble sequences is associated with a first cyclic shift distance between first preamble sequences in the first set of preamble sequences and the second set of preamble sequences is associated with a second cyclic shift distance between second preamble sequences in the second set of preamble sequences, wherein the second cyclic shift distance is at least the first cyclic shift distance.

Aspect 19 is the method of aspect 18, wherein the second cyclic shift distance is greater than the first cyclic shift distance by a value based on a largest cyclic shift value in the third set of cyclic shift values.

Aspect 20 is the method of any of aspects 17 to 19, wherein the second RO is indicated for transmitting additional Msg 1 transmissions associated with prior Msg 1 transmissions in any of a plurality of ROs, wherein the first set of preamble sequences is associated with each of the plurality of ROs, wherein there is a many-to-one mapping from first preamble sequences in the first set of preamble sequences associated with the plurality of ROs to second preamble sequences in the second set of preamble sequences, wherein each RO in the plurality of ROs is associated with a corresponding subset of cyclic shift values in the third set of cyclic shift values that indicate the support for the capability of the UE, wherein the cyclic shift values in each subset of cyclic shift values are disjoint from the cyclic shift values in other subsets of the cyclic shift values, and wherein different first preamble sequences mapped to a same preamble sequence in the second set of preamble sequences are associated with a corresponding different subset of cyclic shift values in the third set of cyclic shift values.

Aspect 21 is the method of aspect 20, wherein the first set of preamble sequences is associated with a first cyclic shift distance between the first preamble sequences in the first set of preamble sequences and the second set of preamble sequences is associated with a second cyclic shift distance between the second preamble sequences in the second set of preamble sequences, wherein the second cyclic shift distance is greater than the first cyclic shift distance by a value based on a largest cyclic shift value in the set of cyclic shift values.

Aspect 22 is the method of any of aspects 11 to 21, wherein the UE is a first UE, the Msg 1 is a first Msg 1, the additional Msg 1 is a first additional Msg 1, the capability of the first UE is a first capability of the first UE, and the Msg 2 is a first Msg 2, the method further comprising: receiving, from a second UE via a third first set of resources associated with a third RO, a second Msg 1 using a third preamble sequence; receiving, from the second UE via the second set of resources associated with the second RO, a second additional Msg 1 using a fourth preamble sequence associated with a second cyclic shift value that indicates the support for a second capability of the second UE, wherein the second additional Msg 1 is based on the second Msg 1; and transmitting, to the second UE, a second Msg 2 based on the second Msg 1 and the second additional Msg 1.

Aspect 23 is the method of aspect 22, further comprising: associating the first Msg 1 with the first additional Msg 1 and associating the second Msg 1 with the second additional Msg 1 based on one or more of: a first timing advance value associated with the first Msg 1 and the first additional Msg 1 received from the first UE and a second timing advance value associated with the second Msg 1 and the second additional Msg 1 received from the second UE, a first set of cyclic shift values associated with the first Msg 1 and the first additional Msg 1 from the first UE and a second set of cyclic shift values associated with the second Msg 1 and the second additional Msg 1 from the second UE, or a first received power associated with the first Msg 1 and the first additional Msg 1 from the first UE and a second received power associated with the second Msg 1 and the second additional Msg 1 received from the second UE; allocating, based on the second preamble sequence, first resources for a third random access message (first Msg 3), wherein the first Msg 2 indicates, to the first UE, a first allocation of the first resources for the first Msg 3; and allocating, based on the fourth preamble sequence, second resources for a second Msg 3, wherein the second Msg 2 indicates, to the second UE, a second allocation of the second resources for the second Msg 3.

Aspect 24 is the method of aspect 23, wherein preamble sequences used by UEs to transmit additional first messages are selected from a set of preamble sequences used to indicate a corresponding set of UE capabilities, and wherein the network node fails to separately detect at least one of the first additional Msg 1 and the second additional Msg 1, wherein the first resources and the second resources are allocated based on one of a first lowest UE capability in the corresponding set of UE capabilities or a second lowest UE capability consistent with the first Msg 1, the first additional Msg 1, the second Msg 1, and the second additional Msg 1 received by the network node.

Aspect 25 is an apparatus for wireless communication at a UE, comprising: at least one memory; and at least one processor coupled to the at least one memory, the at least one processor is configured to perform the method of any of aspects 1 to 10.

Aspect 26 is an apparatus for wireless communication at a UE, comprising means for performing each step in the method of any of aspects 1 to 10.

Aspect 27 is the apparatus of any of aspects 25 and 26, further comprising a transceiver configured to receive or to transmit in association with the method of any of aspects 1 to 10.

Aspect 28 is a computer-readable medium storing computer executable code at a UE, the code when executed by at least one processor causes the at least one processor to perform the method of any of aspects 1 to 10.

Aspect 29 is an apparatus for wireless communication at a network node, comprising: at least one memory; and at least one processor coupled to the at least one memory, the at least one processor is configured to perform the method of any of aspects 11 to 24.

Aspect 30 is an apparatus for wireless communication at a network node, comprising means for performing each step in the method of any of aspects 11 to 24.

Aspect 31 is the apparatus of any of aspects 29 and 30, further comprising a transceiver configured to receive or to transmit in association with the method of any of aspects 11 to 24.

Aspect 32 is a computer-readable medium storing computer executable code at a network node, the code when executed by at least one processor causes the at least one processor to perform the method of any of aspects 11 to 24.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
transmit, via a first set of resources associated with a first random access channel (RACH) occasion (RO), a first random access message (Msg 1) using a first preamble sequence;
transmit, via a second set of resources associated with a second RO, an additional first random access message (additional Msg 1) using a second preamble sequence associated with a first cyclic shift value that indicates support for a capability of the UE, wherein the additional Msg 1 is based on the Msg 1; and
receive a second random access message (Msg 2) based on the Msg 1 and the additional Msg 1.

2. The apparatus of claim 1, wherein the second RO is indicated for additional Msg 1 transmissions associated with prior Msg 1 transmissions in the first RO.

3. The apparatus of claim 2, wherein a first set of preamble sequences, which are based on a first set of root indexes and a first set of cyclic shift values, are associated with both the first RO and the second RO.

4. The apparatus of claim 1, wherein the second RO is indicated for additional Msg 1 transmissions associated with prior Msg 1 transmissions in any of a plurality of ROs, wherein the plurality of ROs comprises the first RO.

5. The apparatus of claim 4, wherein the first preamble sequence is selected by the UE from a first set of preamble sequences comprising a first number of preamble sequences based on a first set of root indexes and a first set of cyclic shift values, wherein the first set of preamble sequences is associated with each of the plurality of ROs, wherein the plurality of ROs comprises a second number of ROs, and wherein the second preamble sequence is associated with one of:
a second set of preamble sequences associated with the second RO, wherein the second set of preamble sequences comprises a third number of preamble sequences based on a second set of root indexes and a second set of cyclic shift values, wherein the third number of preamble sequences is greater than or equal to the first number of preamble sequences multiplied by the second number of ROs, and wherein there is a one-to-one mapping from first preamble sequences in the first set of preamble sequences associated with each RO to second preamble sequences in the second set of preamble sequences; or
a third set of preamble sequences associated with the second RO, wherein the third set of preamble sequences comprises a fourth number of preamble sequences based on a third set of root indexes and a third set of cyclic shift values, wherein the fourth number of preamble sequences is smaller than the first number of preamble sequences multiplied by the second number of ROs, and wherein there is a many-to-one mapping from the first preamble sequences in the first set of preamble sequences associated with the plurality of ROs to third preamble sequences in the third set of preamble sequences.

6. The apparatus of claim 1, wherein the first preamble sequence is selected from a first set of preamble sequences associated with a first set of root indexes and a first set of cyclic shift values, wherein the first preamble sequence is mapped to a corresponding preamble sequence in a second set of preamble sequences for the second RO associated with a second set of root indexes and a second set of cyclic shift values, wherein the corresponding preamble sequence is associated with a particular root index in the second set of root indexes and a particular cyclic shift value in the second set of cyclic shift values, wherein the second preamble sequence is based on the particular root index and an applied cyclic shift value comprising a sum of the particular cyclic shift value and the first cyclic shift value, and wherein the first cyclic shift value is selected from a third set of cyclic shift values.

7. The apparatus of claim 6, wherein the first set of preamble sequences is associated with a first cyclic shift distance between first preamble sequences in the first set of preamble sequences and the second set of preamble sequences is associated with a second cyclic shift distance between second preamble sequences in the second set of preamble sequences, wherein the second cyclic shift distance is greater than or equal to the first cyclic shift distance.

8. The apparatus of claim 7, wherein the second cyclic shift distance is greater than the first cyclic shift distance by a value based on a largest cyclic shift value in the third set of cyclic shift values.

9. The apparatus of claim 6, wherein the second RO is indicated for transmitting additional Msg 1 transmissions associated with prior Msg 1 transmissions in any of a plurality of ROs, wherein the first set of preamble sequences is associated with each of the plurality of ROs, wherein there is a many-to-one mapping from first preamble sequences in the first set of preamble sequences associated with the plurality of ROs to second preamble sequences in the second set of preamble sequences, wherein each RO in the plurality of ROs is associated with a corresponding subset of cyclic shift values in the third set of cyclic shift values that indicate the support for the capability of the UE, wherein the cyclic shift values in each subset of cyclic shift values are disjoint from the cyclic shift values in other subsets of the cyclic shift values, and wherein different first preamble sequences mapped to a same preamble sequence in the second set of preamble sequences are associated with a corresponding different subset of cyclic shift values in the third set of cyclic shift values.

10. The apparatus of claim 9, wherein the first set of preamble sequences is associated with a first cyclic shift distance between the first preamble sequences in the first set of preamble sequences and the second set of preamble sequences is associated with a second cyclic shift distance between the second preamble sequences in the second set of preamble sequences, wherein the second cyclic shift distance is greater than the first cyclic shift distance by a value based on a largest cyclic shift value in the third set of cyclic shift values.

11. An apparatus for wireless communication at a network node, comprising:
at least one memory; and
at least one processor coupled to the at least one memory and, based at least in part on information stored in the at least one memory, the at least one processor is configured to:
receive, from a user equipment (UE) via a first set of resources associated with a first random access channel (RACH) occasion (RO), a first random access message (Msg 1) using a first preamble sequence;
receive, from the UE via a second set of resources associated with a second RO, an additional first random access message (additional Msg 1) using a second preamble sequence associated with a first cyclic shift value that indicates support for a capability of the UE, wherein the additional Msg 1 is based on the Msg 1; and
transmit, to the UE, a second random access message (Msg 2) based on the Msg 1 and the additional Msg 1.

12. The apparatus of claim 11, wherein the second RO is indicated for additional Msg 1 transmissions associated with prior Msg 1 transmissions in the first RO.

13. The apparatus of claim 12, wherein a first set of preamble sequences, which are based on a first set of root indexes and a first set of cyclic shift values, are associated with both the first RO and the second RO.

14. The apparatus of claim 11, wherein the second RO is indicated for additional Msg 1 transmissions associated with prior Msg 1 transmissions in any of a plurality of ROs, wherein the plurality of ROs comprises the first RO.

15. The apparatus of claim 14, wherein the first preamble sequence is selected by the UE from a first set of preamble sequences comprising a first number of preamble sequences based on a first set of root indexes and a first set of cyclic shift values, wherein the first set of preamble sequences is associated with each of the plurality of ROs, wherein the plurality of ROs comprises a second number of ROs, and wherein the second preamble sequence is associated with one of:
a second set of preamble sequences associated with the second RO, wherein the second set of preamble sequences comprises a third number of preamble sequences based on a second set of root indexes and a second set of cyclic shift values, wherein the third number of preamble sequences is greater than or equal to the first number of preamble sequences multiplied by the second number of ROs, and wherein there is a one-to-one mapping from first preamble sequences in the first set of preamble sequences associated with each RO to second preamble sequences in the second set of preamble sequences; or
a third set of preamble sequences associated with the second RO, wherein the third set of preamble sequences comprises a fourth number of preamble sequences based on a third set of root indexes and a third set of cyclic shift values, wherein the fourth number of preamble sequences is smaller than the first number of preamble sequences multiplied by the second number of ROs, and wherein there is a many-to-one mapping from the first preamble sequences in the first set of preamble sequences associated with the plurality of ROs to third preamble sequences in the third set of preamble sequences.

16. The apparatus of claim 11, wherein the first cyclic shift value indicates the support for a first capability of the UE, wherein the at least one processor, individually or in any combination, is further configured to:
allocate, based on the first capability of the UE, resources for a third random access message (Msg 3), and wherein, to transmit the Msg 2, the at least one processor, individually or in any combination, is configured to transmit an indication, to the UE, of an allocation of the resources for transmitting the Msg 3.

17. The apparatus of claim 11, wherein the first preamble sequence is selected from a first set of preamble sequences associated with a first set of root indexes and a first set of cyclic shift values, wherein the first preamble sequence is mapped to a corresponding preamble sequence in a second set of preamble sequences for the second RO associated with a second set of root indexes and a second set of cyclic shift values, wherein the corresponding preamble sequence is associated with a particular root index in the second set of root indexes and a particular cyclic shift value in the second set of cyclic shift values, wherein the second preamble sequence is based on the particular root index and an applied cyclic shift value comprising a sum of the particular cyclic shift value and the first cyclic shift value, and wherein the first cyclic shift value is selected from a third set of cyclic shift values.

18. The apparatus of claim 17, wherein the first set of preamble sequences is associated with a first cyclic shift distance between first preamble sequences in the first set of preamble sequences and the second set of preamble sequences is associated with a second cyclic shift distance between second preamble sequences in the second set of preamble sequences, wherein the second cyclic shift distance is at least the first cyclic shift distance.

19. The apparatus of claim 18, wherein the second cyclic shift distance is greater than the first cyclic shift distance by a value based on a largest cyclic shift value in the third set of cyclic shift values.

20. The apparatus of claim 17, wherein the second RO is indicated for transmitting additional Msg 1 transmissions associated with prior Msg 1 transmissions in any of a plurality of ROs, wherein the first set of preamble sequences is associated with each of the plurality of ROs, wherein there is a many-to-one mapping from first preamble sequences in the first set of preamble sequences associated with the plurality of ROs to second preamble sequences in the second set of preamble sequences, wherein each RO in the plurality of ROs is associated with a corresponding subset of cyclic shift values in the third set of cyclic shift values that indicate the support for the capability of the UE, wherein the cyclic shift values in each subset of cyclic shift values are disjoint from the cyclic shift values in other subsets of the cyclic shift values, and wherein different first preamble sequences mapped to a same preamble sequence in the second set of preamble sequences are associated with a corresponding different subset of cyclic shift values in the third set of cyclic shift values.

21. The apparatus of claim 20, wherein the first set of preamble sequences is associated with a first cyclic shift distance between the first preamble sequences in the first set of preamble sequences and the second set of preamble sequences is associated with a second cyclic shift distance between the second preamble sequences in the second set of preamble sequences, wherein the second cyclic shift distance is greater than the first cyclic shift distance by a value based on a largest cyclic shift value in the set of cyclic shift values.

22. The apparatus of claim 11, wherein the UE is a first UE, the Msg 1 is a first Msg 1, the additional Msg 1 is a first additional Msg 1, the capability of the first UE is a first capability of the first UE, and the Msg 2 is a first Msg 2, wherein the at least one processor, individually or in any combination, is further configured to:
receive, from a second UE via a third first set of resources associated with a third RO, a second Msg 1 using a third preamble sequence;
receive, from the second UE via the second set of resources associated with the second RO, a second additional Msg 1 using a fourth preamble sequence associated with a second cyclic shift value that indicates the support for a second capability of the second UE, wherein the second additional Msg 1 is based on the second Msg 1; and
transmit, to the second UE, a second Msg 2 based on the second Msg 1 and the second additional Msg 1.

23. The apparatus of claim 22, wherein the at least one processor, individually or in any combination, is further configured to:
associate the first Msg 1 with the first additional Msg 1 and associating the second Msg 1 with the second additional Msg 1 based on one or more of:
a first timing advance value associated with the first Msg 1 and the first additional Msg 1 received from the first UE and a second timing advance value associated with the second Msg 1 and the second additional Msg 1 received from the second UE,
a first set of cyclic shift values associated with the first Msg 1 and the first additional Msg 1 from the first UE and a second set of cyclic shift values associated with the second Msg 1 and the second additional Msg 1 from the second UE, or
a first received power associated with the first Msg 1 and the first additional Msg 1 from the first UE and a second received power associated with the second Msg 1 and the second additional Msg 1 received from the second UE;
allocate, based on the second preamble sequence, first resources for a third random access message (first Msg 3), wherein the first Msg 2 indicates, to the first UE, a first allocation of the first resources for the first Msg 3; and
allocate, based on the fourth preamble sequence, second resources for a second Msg 3, wherein the second Msg 2 indicates, to the second UE, a second allocation of the second resources for the second Msg 3.

24. The apparatus of claim 23, wherein preamble sequences used by UEs to transmit additional first messages are selected from a set of preamble sequences used to indicate a corresponding set of UE capabilities, and wherein the network node fails to separately detect at least one of the first additional Msg 1 and the second additional Msg 1, wherein the first resources and the second resources are allocated based on one of a first lowest UE capability in the corresponding set of UE capabilities or a second lowest UE capability consistent with the first Msg 1, the first additional Msg 1, the second Msg 1, and the second additional Msg 1 received by the network node.

25. A method of wireless communication at a user equipment (UE), comprising:
transmitting, via a first set of resources associated with a first random access channel (RACH) occasion (RO), a first random access message (Msg 1) using a first preamble sequence;
transmitting, via a second set of resources associated with a second RO, an additional first random access message (additional Msg 1) using a second preamble sequence associated with a first cyclic shift value that indicates support for a capability of the UE, wherein the additional Msg 1 is based on the Msg 1; and
receiving a second random access message (Msg 2) based on the Msg 1 and the additional Msg 1.

26. The method of claim 25, wherein the second RO is indicated for additional Msg 1 transmissions associated with prior Msg 1 transmissions in any of a plurality of ROs, wherein the plurality of ROs comprises the first RO.

27. The method of claim 26, wherein the first preamble sequence is selected by the UE from a first set of preamble sequences comprising a first number of preamble sequences based on a first set of root indexes and a first set of cyclic shift values, wherein the first set of preamble sequences is associated with each of the plurality of ROs, wherein the plurality of ROs comprises a second number of ROs, and wherein the second preamble sequence is associated with one of:
a second set of preamble sequences associated with the second RO, wherein the second set of preamble sequences comprises a third number of preamble sequences based on a second set of root indexes and a second set of cyclic shift values, wherein the third number of preamble sequences is greater than or equal to the first number of preamble sequences multiplied by the second number of ROs, and wherein there is a one-to-one mapping from first preamble sequences in the first set of preamble sequences associated with each RO to second preamble sequences in the second set of preamble sequences; or
a third set of preamble sequences associated with the second RO, wherein the third set of preamble sequences comprises a fourth number of preamble sequences based on a third set of root indexes and a third set of cyclic shift values, wherein the fourth number of preamble sequences is smaller than the first number of preamble sequences multiplied by the second number of ROs, and wherein there is a many-to-one mapping from the first preamble sequences in the first set of preamble sequences associated with the plurality of ROs to third preamble sequences in the third set of preamble sequences.

28. A method of wireless communication at a network node, comprising:
receiving, from a user equipment (UE) via a first set of resources associated with a first random access channel (RACH) occasion (RO), a first random access message (Msg 1) using a first preamble sequence;
receiving, from the UE via a second set of resources associated with a second RO, an additional first random access message (additional Msg 1) using a second preamble sequence associated with a first cyclic shift value that indicates support for a capability of the UE, wherein the additional Msg 1 is based on the Msg 1; and
transmitting, to the UE, a second random access message (Msg 2) based on the Msg 1 and the additional Msg 1.

29. The method of claim 28, wherein the UE is a first UE, the Msg 1 is a first Msg 1, the additional Msg 1 is a first additional Msg 1, the capability of the first UE is a first capability of the first UE, and the Msg 2 is a first Msg 2, the method further comprising:
receiving, from a second UE via a third first set of resources associated with a third RO, a second Msg 1 using a third preamble sequence;
receiving, from the second UE via the second set of resources associated with the second RO, a second additional Msg 1 using a fourth preamble sequence associated with a second cyclic shift value that indicates the support for a second capability of the second UE, wherein the second additional Msg 1 is based on the second Msg 1; and
transmitting, to the second UE, a second Msg 2 based on the second Msg 1 and the second additional Msg 1.

30. The method of claim 29, further comprising:
associating the first Msg 1 with the first additional Msg 1 and associating the second Msg 1 with the second additional Msg 1 based on one or more of:
a first timing advance value associated with the first Msg 1 and the first additional Msg 1 received from the first UE and a second timing advance value associated with the second Msg 1 and the second additional Msg 1 received from the second UE,
a first set of cyclic shift values associated with the first Msg 1 and the first additional Msg 1 from the first UE and a second set of cyclic shift values associated with the second Msg 1 and the second additional Msg 1 from the second UE, or
a first received power associated with the first Msg 1 and the first additional Msg 1 from the first UE and a second received power associated with the second Msg 1 and the second additional Msg 1 received from the second UE;
allocating, based on the second preamble sequence, first resources for a third random access message (first Msg 3), wherein the first Msg 2 indicates, to the first UE, a first allocation of the first resources for the first Msg 3; and
allocating, based on the fourth preamble sequence, second resources for a second Msg 3, wherein the second Msg 2 indicates, to the second UE, a second allocation of the second resources for the second Msg 3.
